(19) United States
(12) Patent Application Publication
(10) Pub. No.: US 2019/0032686 A1
(43) Pub. Date: Jan. 31, 2019

(54) SYSTEM AND METHOD FOR PNEUMATICALLY CHARGING AND DISCHARGING A WORKING VESSEL USING 2-WAY VALVES AND 3-WAY VALVES

(71) Applicant: Nexmatix LLC, St. Louis, MO (US)

(72) Inventors: Ellen Mell, Farmington, MO (US); Dennis Mell, Farmington, MO (US); Michael Goldfarb, Franklin, TN (US)

(73) Assignee: Nexmatix LLC, St. Louis, MO (US)

(21) Appl. No.: 16/071,703

(22) PCT Filed: Jan. 20, 2017
(86) PCT No.: PCT/US17/14391

§ 371 Date: Jul. 20, 2018

Related U.S. Application Data
(60) Provisional application No. 62/345,541, filed on Jun. 3, 2016.
(60) Provisional application No. 62/345,512, filed on Jun. 3, 2016.
(60) Provisional application No. 62/281,115, filed on Jan. 20, 2016.

(51) Int. Cl. F15B 21/14; F15B 11/064; B29C 49/06

(52) U.S. Cl. CPC F15B 21/14; F15B 11/064; B29C 49/06; F15B 2211/8855; F15B 2211/7052; F15B 2211/88; F15B 2211/7053; F15B 2211/3057

(57) ABSTRACT

An energy-saving charge/discharge method controls the repeated charging and discharging of a working vessel in a manner that enables the storage and subsequent reuse of compressed gas during the repeated charge and discharge cycle. In contrast to the methods of the prior art, the method does not discard the entire mass of compressed gas during each discharge phase of the cycle. An energy savings results from the recycling of compressed gas, which reduces the net consumption of compressed gas for a given charge/discharge cycle of a given pressure vessel. A minimum amount of apparatus is required to implement the recycling of compressed gas.

### CROSS REFERENCE TO RELATED APPLICATION

This application claims the benefit of and incorporates by reference the entirety of PCT Patent Application No. PCT/U.S. Ser. No. 17/14,391 filed on Jan. 20, 2017; U.S. Provisional Application No. 62/345,541 filed on Jun. 3, 2016; U.S. 62/345,512 filed on Jun. 3, 2016 and U.S. Provisional Application No. 62/281,115 filed on Jan. 20, 2016.

### STATEMENT REGARDING FEDERALLY SPONSORED RESEARCH OR DEVELOPMENT

Not applicable.

### SEQUENCE LISTING, TABLE OR COMPUTER PROGRAM ON COMPACT DISC

Not applicable.

### FIELD OF INVENTION

This invention relates generally to pneumatic circuits utilizing directional control valves and more particularly to systems and methods for operating same.

### BACKGROUND OF THE INVENTION

Certain industrial applications require the charging and subsequent discharging of a working vessel with compressed gas in a repeated cycle. For example, in blow molding applications, a part mold (the working vessel) is filled with compressed gas during the molding process. After the part is formed, the compressed gas used to pressurize the mold is subsequently discharged from the mold. The process of charging (i.e., pressurizing) and subsequent discharging (i.e., depressurizing) of the mold with compressed gas is repeated for the next molded part.

Another example of a process involving repeated charging and discharging of a working vessel is the actuation of a single-acting pneumatic cylinder (a/k/a “actuator”). The fluid chamber of a single-acting pneumatic cylinder is a working vessel that is actuated by a single compressed gas line, and for which compressed gas (typically air) is used to effect either the retraction or extension stroke of a piston and rod assembly within the cylinder, while a spring is used to effect the opposing stroke (i.e., extension or retraction, respectively). As such, repeated extension and retraction of the piston and rod assembly requires repeated charging and discharging of the compressed gas side (chamber) of the pneumatic cylinder. The mold in a blow molding application, and the cylinder in a single-acting pneumatic cylinder, can each be regarded as a working (pressure) vessel, which in general is a volume of space that is pressurized with compressed gas.

A double-acting pneumatic cylinder uses the force of fluid (typically air) to move in both the extension and retraction strokes. The typical double-acting cylinder includes a piston housing (the cylinder) that encapsulates a piston that can slidably move within the housing along its length. The piston divides the piston housing into two chambers (a first and second chamber), the size of each chamber is variable and depends upon the location of the piston within the housing. Thus, a double-acting cylinder has two ports, one for each chamber, to allow air in. Air entering into one chamber and pressing against the piston will effect an extension (or retraction) stroke of the piston, while air entering the other chamber and pressing against the piston will effect a respective counter retraction (or extension) stroke of the piston. When the fluid in one chamber is at a higher pressure than the fluid in the other chamber, the piston will be caused to move in the direction of the low pressure chamber. Some double-acting cylinders include biasing springs within one or more of the chambers so as to regulate the expansion of the chambers; the biasing spring typically serving to counteract a chosen amount of movement of the piston into the chamber in which the spring is located. As with the single-acting pneumatic cylinder, the chambers of a double-acting pneumatic cylinder can also each be regarded as a working pressure vessel.

The processes of pressurizing and depressurizing (or charging and discharging) a working vessel (or pressure vessel) in applications such as are described above are often controlled by a 3-way valve. A typical 2-position, 3-way, 3-port valve (hereafter called a 3-way valve) is defined for purposes of this application as one that selectively connects three fluid ports in one of two respective port connectivity positions. A schematic diagram of the port connectivity provided by a standard 3-way valve 1 is shown in FIG. 1, where the labels P1 and P2 correspond to first and second valve positions, respectively. Although various arrangements of the three ports are possible, in keeping with a conventional usage, the three ports will be respectively referred to here as the supply (conventionally labeled in technical drawings with the letter “S”), exhaust (conventionally labeled in technical drawings with the letter “E”), and the outlet port (conventionally labeled in technical drawings with the letter “A”). Given this nomenclature, a standard 3-way valve can either be configured into a first position P1, which provides a port connectivity configuration in which outlet port A is connected to supply port S, and exhaust port E is isolated; or into a second position P2, which provides a port connectivity configuration in which outlet port A is connected to (in fluid communication with) exhaust port E, and supply port S is isolated (fluid flow between the supply port and all of the other ports of the valve is prevented). As shown in FIG. 2, supply port S is in fluid communication with pressure supply 2, which supplies a compressed fluid for the relevant industrial application. Exhaust port E is in fluid communication with (discharges to) an exhaust 6, which is typically atmosphere or exhaust piping or receptacle. In some cases, a 3-way valve may include a third position P3, which corresponds to a third port connectivity configuration, such as one in which all ports are isolated. In typical operation, however, only the first and second valve positions (i.e., port connectivity configurations) P1, P2 are used.

FIGS. 2 and 3 show a typical configuration in which a 3-way valve 1 is used to control the charging and discharging of a working vessel 3 via gas line 30. As shown in FIG. 2, when valve 1 is in a first position P1, outlet port A is connected to supply port S, and working vessel 3 is charged (i.e., pressurized). As shown in FIG. 3, when valve 1 is in a second position P2, outlet port A is connected to exhaust port E, and the compressed gas in working vessel 3 is discharged through exhaust port E. Although valve 1 might be moved between positions P1 and P2 manually, in most automated applications, valve 1 is moved between the first and second positions P1, P2 via electrical actuation, such as via direct or pilot-actuated solenoid operation.

The processes of pressurizing and depressurizing (or charging and discharging) a working vessel in applications such as are described above are also often controlled by a 2-way, 2-position valve (hereafter called a 2-way valve). The repeated actuation of a working vessel such as the chamber of a single-acting actuator or double-acting actuator can be implemented by using 2-way valves. A schematic representation of an application using two 2-way valves is shown in FIG. 36. As seen in the figure, a 2-way valve has a first port and a second port. A 2-way valve is defined for purposes of this application as one that be configured into a first valve position P1 and a second valve position P2, where in the first valve position P1 the two ports are in fluid isolation, and where in the second valve position P2 the two ports are in fluid communication. In a typical application as shown in FIG. 36, two 2-way valves can be used to pressurize and subsequently depressurize a working vessel by connecting a first 2-way valves to a pressure source and the working vessel and by connecting a second 2-way valve to an exhaust and to the same working vessel. As shown in FIG. 36, by placing the first 2-way valve in position P2 and the second 2-way valve in position P1, the working vessel will be fluidly connected to the pressure source and the working vessel will be pressurized. By switching both valves to the opposition position, specifically by switching the first 2-way valve in position P1 and the second 2-way valve in position P2, the working vessel will then be fluidly connected to the exhaust and the working vessel will be depressurized.

The pneumatic circuit of the prior art, whether using 2-way or 3-way valves suffers from the fact that it is not energy efficient and is not deployed in an energy efficient manner. For example, in the case of a 3-way valve circuit, during the course of a typical repeated charge and discharge cycle (as illustrated in FIGS. 2 and 3), the entire mass of compressed gas contained within working vessel 3 is vented to atmosphere after each cycle. This discharge is inefficient and requires the provision of a new volume of compressed gas for each application. The same discharge occurs with prior art pneumatic circuits using 2-way valves. Rather than discard the entire mass of compressed gas during each discharge phase of the cycle, it would be desirable to reduce the consumption of compressed air by temporarily storing a portion of the compressed gas during the discharge process, and subsequently reusing a portion of the stored compressed gas during the following charging portion of the cycle.

### SUMMARY OF THE INVENTION

The present invention is directed to improved systems and methods that reserve compressed gas for use in an application cycle. More specifically, this application describes embodiments of energy-saving charge/discharge systems and methods that use 2-way valve circuits and 3-way valve circuits to control the repeated charging and discharging of a working vessel in a manner that enables the storage and subsequent reuse of compressed gas during the repeated charge and discharge cycle. In contrast to the methods of the prior art, the present invention method does not discard the entire mass of compressed gas during each discharge phase of the cycle. An energy savings results from the recycling of compressed gas, which reduces the net consumption of compressed gas for a given charge/discharge cycle of a given working vessel.

The present invention systems and methods allow for the storage and reuse of compressed gas with a minimal amount of additional apparatus, and with minimal requirement for system reconfiguration, relative to a conventional implementation. A minimum amount of apparatus is required to implement the recycling of compressed gas. The present invention systems and methods reduce the consumption of compressed air by permitting the temporary storing of a portion of the compressed gas in a pressure reservoir during the discharge process. The valves can be actuated to reuse a portion of the stored compressed gas during the following charging portion of the cycle.

### BRIEF DESCRIPTION OF THE DRAWINGS

FIG. 1 is a schematic diagram of port connectivity for a standard 2-position, 3-way, 3-port valve.

FIG. 2 is a schematic diagram of a standard configuration for a working vessel charging via a standard 3-way control valve, the diagram showing the control valve in the first position.

FIG. 3 is a schematic diagram showing a standard configuration for a working vessel discharging via a standard 3-way control valve, the diagram showing the control valve in the second position.

FIGS. 4-7 illustrate an embodiment pneumatic system and method for the repeated charging and discharging of a working vessel using a plurality of standard 3-way valves. The figures show the configuration of the valves as the system goes through the states in which the pressure vessel is charged and discharged. The shown system depicting an optional arrangement having sensors and a controller.

FIGS. 8-11 illustrate an alternate embodiment pneumatic system and method for the repeated actuation of a single-acting actuator using a plurality of standard 3-way valves. The figures show the configuration of the valves as the system goes through the states in which the cylinder is configured between the first and second actuation positions. The figures illustrate a single-acting rod-style cylinder that uses pressurization for its retracted state, but this embodiment is not meant to be limiting.

FIGS. 12-19 illustrate an embodiment pneumatic system and method for the repeated actuation of a double-acting actuator using the temporary storage of a portion of compressed gas during the discharge process, and subsequently reusing a portion of the stored compressed gas during the following charging portion of the cycle. The disclosed system employs a plurality of standard 3-way control valves to effect the principle. The figures show the configuration of the valves as the system goes through the states in which the chambers of the double-acting actuator are charged and discharged.

FIGS. 20-23 illustrate an embodiment pneumatic system and method for the repeated charging and discharging of a working vessel using a plurality of standard 2-way valves. The figures show the configuration of the valves as the system goes through the states in which the working vessel is charged and discharged.

FIGS. 24-27 illustrate an alternate embodiment pneumatic system and method for the repeated actuation of a single-acting actuator using a plurality of standard 2-way valves. The figures show the configuration of the valves as the system goes through the states in which the cylinder is configured between the first and second actuation positions. The figures illustrate the actuator as a single-acting rod-style cylinder that uses pressurization for its retracted state, but this embodiment is not meant to be limiting.

FIGS. 28-35 illustrate an alternate embodiment system and method for the repeated actuation of a double-acting actuator using a plurality of standard 2-way valves. The figures show the configuration of the valves as the system goes through the states in which the actuator is configured between the first and second actuation positions.

FIG. 36 shows a typical application in which two 2-way valves can be used to pressurize and subsequently depressurize a working vessel.

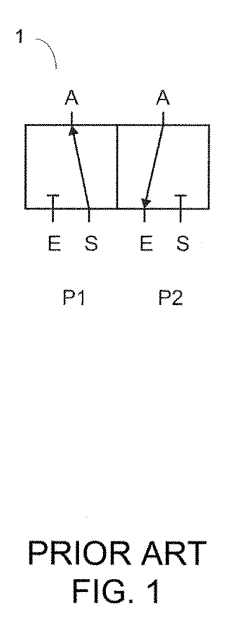

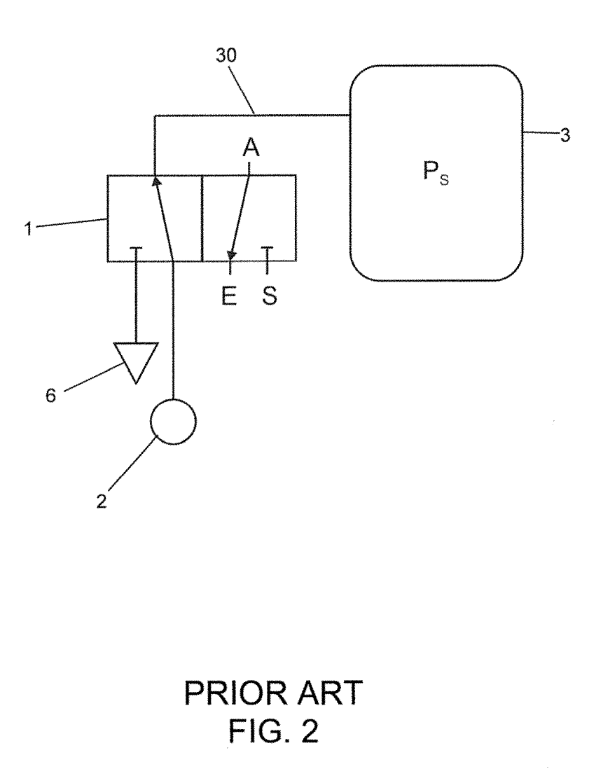

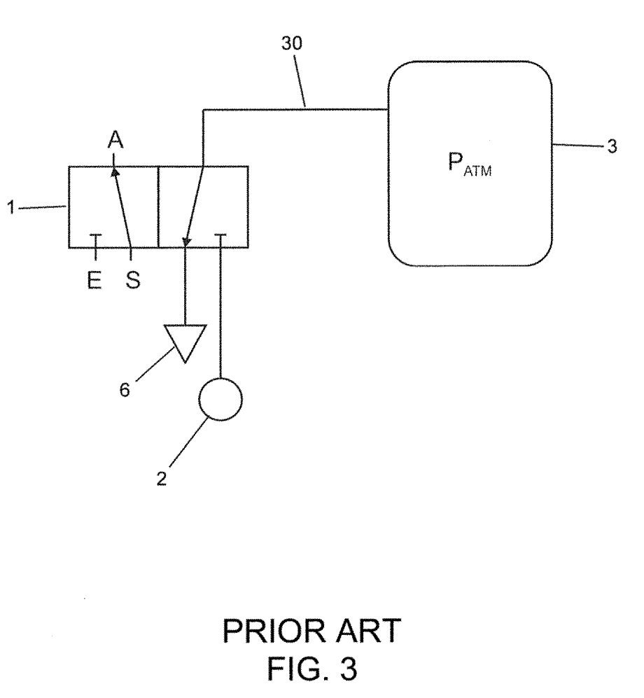

### DETAILED DESCRIPTION

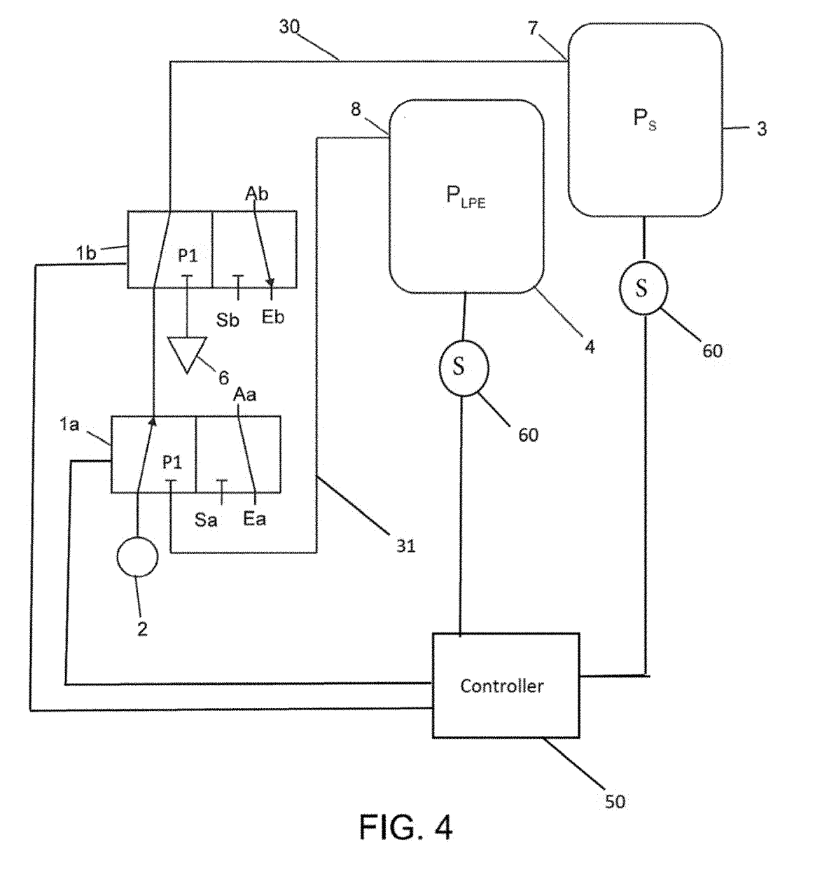

The inventive systems and methods will now be described in the context of their preferred embodiments. The inventive method of the temporary storage and re-use of compressed gas during the repeated charging and discharging of a working vessel can be implemented by using a plurality of standard 3-way valves 1a, 1b, configured as shown in FIGS. 4-7. An embodiment energy saving method employs a fluid supply 2, a working vessel 3, a fluid reservoir 4, and first three-way control valve 1a and second three-way control valve 1b. Each three-way control valve 1a, 1b respectively includes a supply port Sa, Sb, an exhaust port Ea, Eb and an outlet port Aa and Ab. Valves 1a, 1b can each can be configured into a first valve position P1 and a second valve position P2. In the first valve position P1, supply port S is in fluid communication with outlet port A, while exhaust port E is isolated. In the second valve position P2, exhaust port E is in fluid communication with outlet port A, while supply port S is isolated. Working vessel 3 and reservoir 4 each respectively include at least one fluid port 7, 8.

The ports of each respective component are connected as follows. Supply port Sa of first valve 1a is connected to fluid supply 2. Exhaust port Ea of first valve 1a is connected to fluid port 8 of reservoir 4 via line 31. Outlet port Ab of second valve 1b is connected to fluid port 7 of working vessel 3 via line 30. Supply port Sb of second valve 1b is connected to outlet port Aa of first valve 1a. Exhaust port Eb of second valve 1b is connected to exhaust 6.

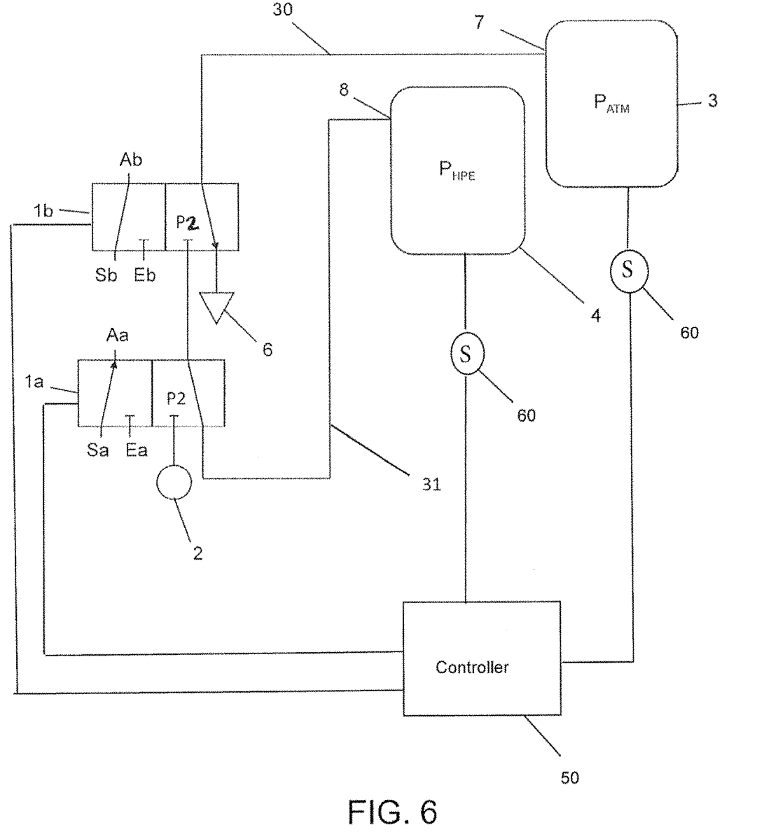

As illustrated in FIG. 4, working vessel 3 is maintained in a charged state when the first and second valves 1a, 1b are configured respectively in the first valve position P1. As illustrated in FIG. 6, working vessel 3 is maintained in a discharged state when first and second valves 1a, 1b are configured respectively in the second valve position P2.

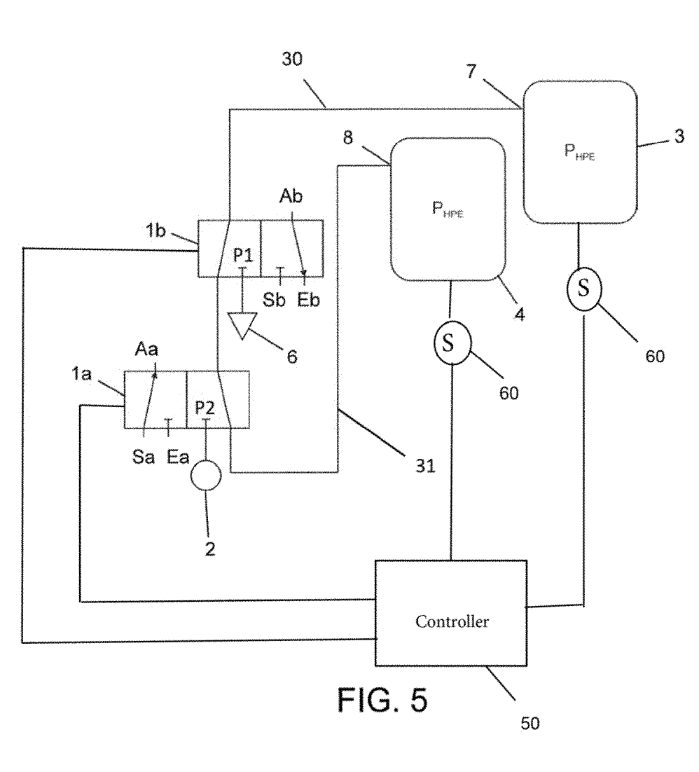

Working vessel 3 is configured from the charged state of FIG. 4 and into the discharged state of FIG. 6 by first configuring first valve 1a from the first valve position P1 into the second valve position P2. This is shown in FIG. 5. The configuration of FIG. 5 enables compressed gas to flow from working vessel 3 to reservoir 4. Subsequently configuring second valve 1b from the first valve position P1 to the second valve position P2 (FIG. 6) discharges the remaining compressed gas in working vessel 3 to exhaust.

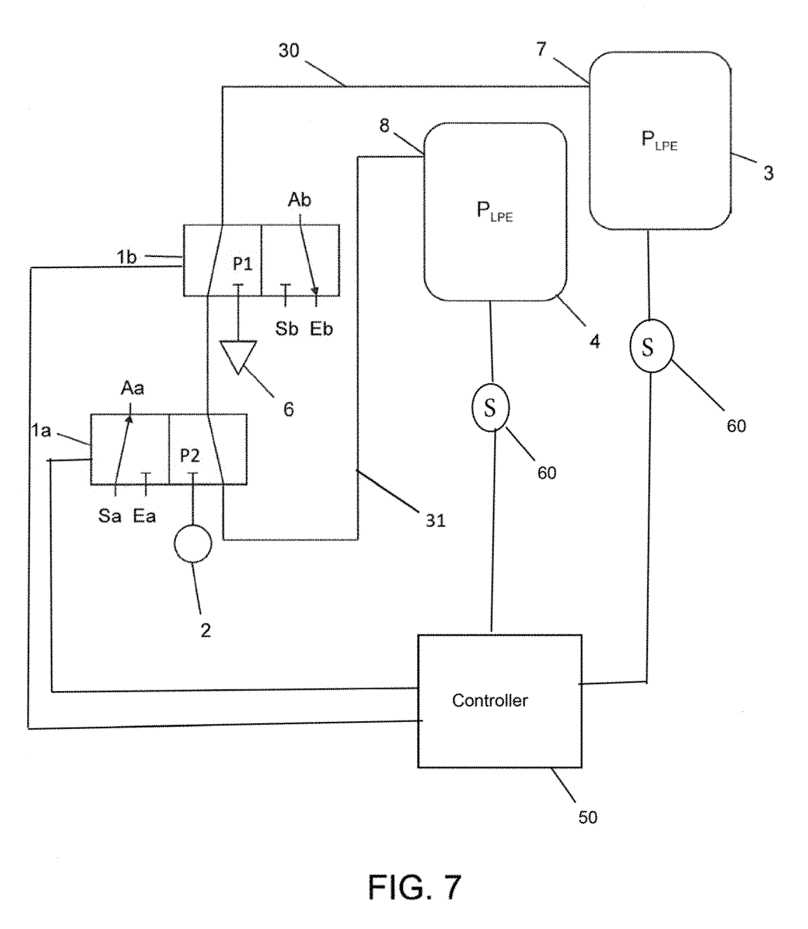

Working vessel 3 is configured from the discharged state of FIG. 6 to the charged state of FIG. 4 by first configuring second valve 1b from the second valve position P2 into the first valve position P1. This is shown in FIG. 7. This configuration enables compressed gas to flow from reservoir 4 to working vessel 3. Subsequently configuring first valve 1a from the second valve position P2 to the first valve position P1 as shown in FIG. 4 fully charges the pressure vessel via supply 2.

The process of compressed gas savings can be modelled as follows. Assuming ideal gas constitutive behavior, isothermal processes, and constant-volume chambers, one can show that the high-pressure equilibrium pressure is given by:

$${P}_{HPE} ( k ) = ( \frac{1}{1 + {V}_{R}} ) ( {P}_{S} + {V}_{R} {P}_{LPE} ( k - 1 ) ) \qquad ( 1 )$$

where V_{R} is the volume ratio between the reservoir 4 and pressure vessel 3, given by:

$${V}_{R} = \frac{{V}_{B}}{{V}_{A}} \qquad ( 2 )$$

where V_{A} and V_{B} are the volumes of a working vessel 3 and reservoir 4, respectively, k denotes the charge/discharge cycle (where k=1 is the first cycle), P_{HPE}(k) is the high-pressure equilibrium pressure at the current charge/discharge cycle, P_{LPE}(k−1) is the low-pressure equilibrium pressure during the previous change/discharge cycle, and P_{S} is the supply pressure. Given similar assumptions, the low-pressure equilibrium pressure at the current cycle is given by:

$${P}_{LPE} ( k ) = ( \frac{1}{1 + {V}_{R}} ) ( {P}_{ATM} + {V}_{R} {P}_{HPE} ( k ) ) \qquad ( 3 )$$

where P_{LPE}(k) is the low-pressure equilibrium pressure at the current charge/discharge cycle k, P_{HPE}(k) is the high-pressure equilibrium pressure at the current cycle given by (1), and P_{ATM} is atmospheric pressure. Equations (1) and (3) can be combined to yield a single recursive equation for the low-pressure equilibrium pressure:

$${P}_{LPE} ( k ) = ( \frac{1}{1 + {V}_{R}} ) ( {P}_{ATM} + {V}_{R} ( \frac{1}{1 + {V}_{R}} ) ( {P}_{S} + {V}_{R} {P}_{LPE} ( k - 1 ) ) ) \qquad ( 4 )$$

This equation is a first-order difference equation of the form:

$$\begin{matrix}{P}_{LPE} ( k ) = {aP}_{LPE} ( k - 1 ) + b & ( 5 ) \\ where & \\ a = {( \frac{{V}_{R}}{1 + {V}_{R}} )}^{2} & ( 6 ) \\ and & \\ b = ( \frac{1}{1 + {V}_{R}} ) \tilde{P} & ( 7 ) \\ where & \\ \tilde{P} = ( {P}_{ATM} + ( \frac{{V}_{R}}{1 + {V}_{R}} ) {P}_{S} ) & ( 8 )\end{matrix}$$

The solution for the first-order difference equation (5) is given by:

$${P}_{LPE} ( k ) = {a}^{k} {P}_{LPE} ( 0 ) + \frac{b ( {a}^{k} - 1 )}{a - 1} \qquad ( 9 )$$

Assuming reservoir 4 is fully depressurized at the start of the charge/discharge process, the initial pressure, P_{LPE}(0) in (9) is P_{ATM}. Equation (9) is stable if and only if α<1, which based on equation (6), will always be true. As such, the difference equation (9) will converge at a sufficient number of cycles to a steady-state equilibrium pressure given by:

$${\overline{P}}_{LPE} = \frac{b}{1 - a} \qquad ( 10 )$$

Substituting equations (6-8) into equation (11) yields a low-pressure equilibrium pressure in the steady state of:

$${\overline{P}}_{LPE} = ( \frac{1 + {V}_{R}}{1 + 2 {V}_{R}} ) \tilde{P} \qquad ( 11 )$$

Combining equations (9) and (10), one can show that the number of cycles required to obtain a fraction γ of the steady state pressure, assuming the initial pressure in the reservoir is P_{ATM}, is given by:

$$k = ( \frac{ln ( ( 1 - γ ) b ) - ln ( ( a - 1 ) {P}_{ATM} + b )}{ln a} ) \qquad ( 12 )$$

Assuming, for example, a reservoir 4 of equal volume to the pressure vessel 3 (i.e., V_{R}=1), one can show from equation (12) that the low-pressure equilibrium pressure will reach 95% of its steady-state value (i.e., γ=0.95) after three cycles. Assuming the system reaches the steady-state low-pressure equilibrium pressure given by equation (12), and continuing the assumptions of ideal gas behavior and an isothermal process, the ratio of mass recycled during each cycle to total charge mass can be written as:

$$\frac{{m}_{r}}{{m}_{A}} = \frac{{\overline{P}}_{LPE}}{{P}_{S}} \qquad ( 13 )$$

where mᵣ is the mass of compressed gas recycled from the previous cycle and m_{A} is the total mass of compressed gas required to charge working vessel 3. The amount of mass required to charge working vessel 3 without recycling is given by:

$${m}_{A} = \frac{( {P}_{S} - {P}_{ATM} ) {V}_{A}}{RT} \qquad ( 14 )$$

where RT is the product of the ideal gas constant and the nominal gas temperature (i.e., a constant under the assumed isothermal conditions). The amount of mass required to charge vessel 3 with recycling is given by:

$${m}_{AB} = \frac{( {P}_{S} - {\overline{P}}_{LPE} ) {V}_{A}}{RT} \qquad ( 15 )$$

As such, the amount of compressed gas required for each charge cycle relative to the amount without recycling is given by:

$$p = \frac{{m}_{AR}}{{m}_{A}} = \frac{{P}_{S} - {\overline{P}}_{LPE}}{{P}_{S} - {P}_{ATM}} \qquad ( 16 )$$

and therefore the compressed gas savings relative to a standard system is given by:

η=1−p (17)

Assuming, for example, reservoir 4 is of equal volume to pressure vessel 3 (i.e., V_{R}=1), atmospheric pressure of 0.1 MPa (1 bar), and a supply pressure of 0.6 MPa (6 bars), the steady-state low-pressure equilibrium pressure would be:

P̅_{LPE}=(2/3)(P_{ATM}+(1/2)P_{S})=(2/3)(1/6+1/2)P_{S}=(2/3)²P_{S} (18)

such that the compressed gas savings would be p=⅔ and the savings relative to a standard process given by η=⅓ (33% savings). In the limit that reservoir 4 becomes much larger than pressure vessel 3, assuming the same ratio of atmospheric to supply pressure (1:6), the steady-state low-pressure equilibrium pressure will approach:

P̅_{LPE}≈(1/2)(P_{ATM}+P_{S})=(1/2)(1/6+1)P_{S}=(7/12)P_{S} (19)

such that the compressed gas savings will approach p≈1/2, and the savings relative to a standard process will similarly approach η=½ (50% savings). In the case that no pressure reservoir 3 is used (i.e., V_{R}=0), the steady-state equilibrium pressure will be P̅_{LPE}=P_{ATM}, the relative mass requirement p=1, and the relative savings η=0 (i.e., no savings possible without a pressure reservoir. The foregoing discussion regarding the modelling of compressed gas savings is equally applicable to the inventive 2-way valve circuits discussed below.

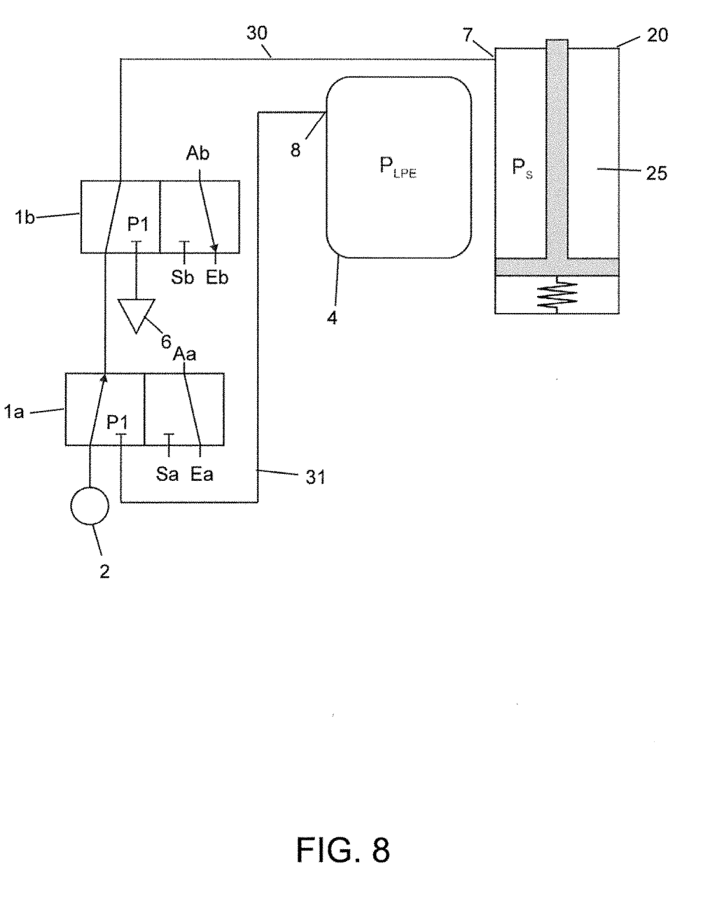

In a further embodiment, the method for the temporary storage and re-use of compressed gas can be employed to effect the repeated actuation of a single-acting actuator 20 (e.g., a working vessel) by using a plurality of standard 3-way valves 1. This method is shown in FIGS. 8-12. The embodiment energy saving method employs a fluid supply 2, a single-acting actuator 20, a fluid reservoir 4, a first three-way control valve 1a and a second three-way control valve 1b. Each three-way control valve 1a, 1b includes a supply port S, at least one exhaust port E and an outlet port A. Valves 1a, 1b can each be configured into a first valve position and a second valve position. In the first valve position, supply port S is in fluid communication with outlet port A, while exhaust port E is isolated. In the second valve position, outlet port A is in fluid communication with exhaust port E, while supply port S is isolated. The single-acting actuator 20 and reservoir 4 respectively include at least one fluid port 7, 8.

The ports of each respective component are connected as follows. Outlet port Ab of second valve 1b is connected via line 30 to fluid port 7 of actuator 20. Supply port Sb of second valve 1b is connected to outlet port Aa of first valve 1a. Exhaust port Eb of second valve 1b is connected to exhaust 6. Supply port Sa of first valve 1a is connected to fluid supply 2. Exhaust port Ea of first valve 1a is connected via line 31 to port 8 of reservoir 4.

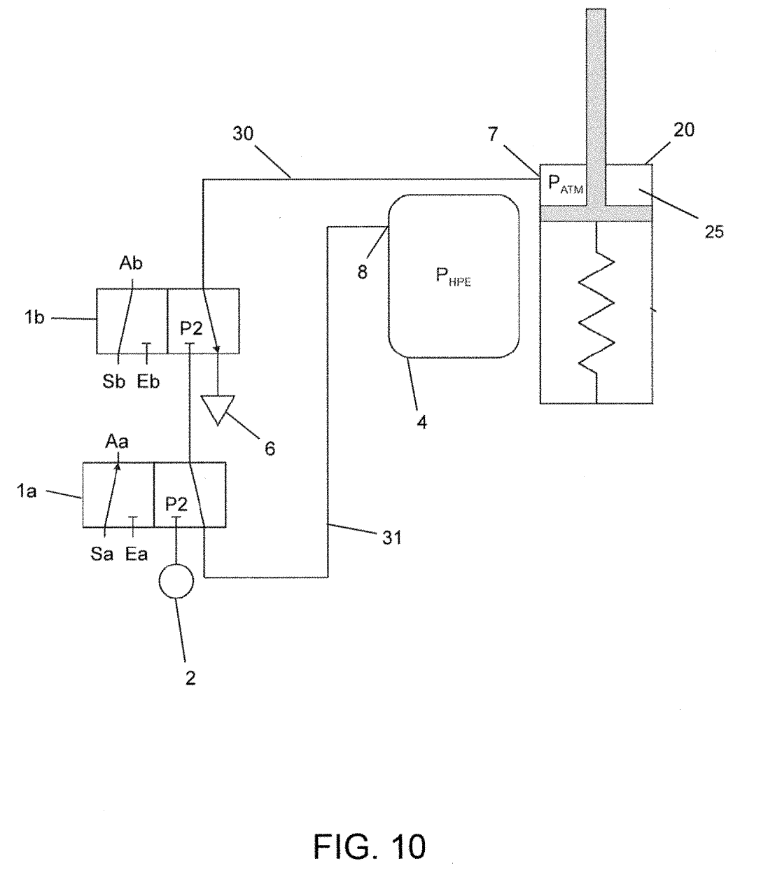

As illustrated in FIG. 8, actuator 20 is configured into a first actuator position (piston retracted) when first valve 1a and second valve 1b are configured respectively in the first valve position. As illustrated in FIG. 10, actuator 20 is configured into a second actuator position when first valve 1a and second valve 1b are configured respectively in the second valve position.

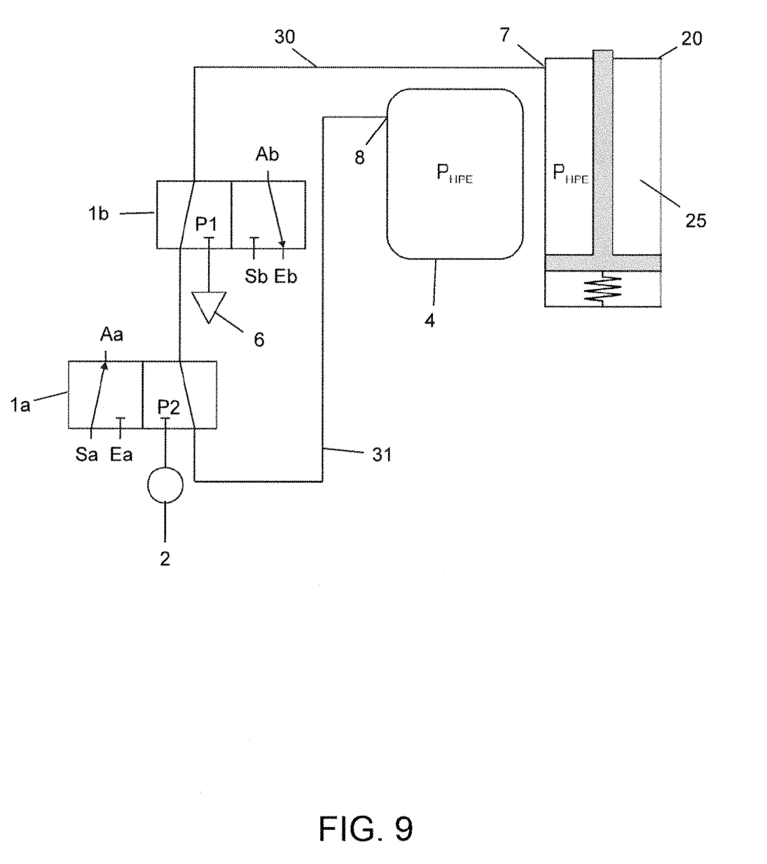

Single-acting actuator 20 is configured to move from the first actuator position of FIG. 8 to the second actuator position of FIG. 10 by first configuring first valve 1a from the first valve position into the second valve position as shown in FIG. 9. This configuration of valve 1a enables compressed gas to flow from the pressurized chamber 25 of actuator 20 to reservoir 4. Subsequently configuring the second valve 1b from the first valve position to the second valve position as shown in FIG. 10 allows the discharge of the remaining compressed gas in the actuator chamber 25 to exhaust 6, which configures actuator 20 into the second actuator position (extended piston).

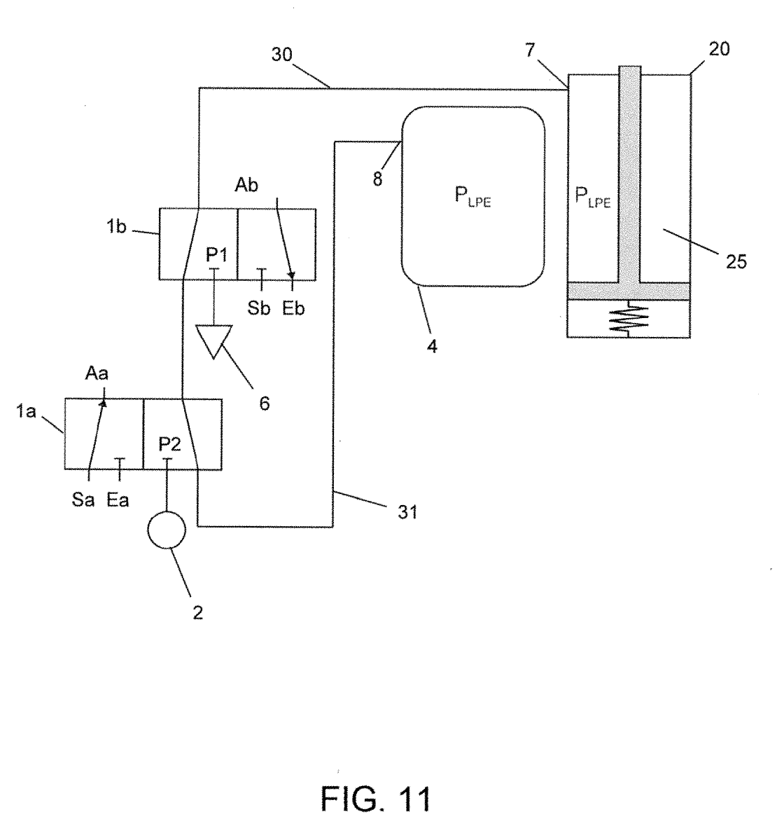

Single-acting actuator 20 is configured to move from the second actuator position depicted in FIG. 10 into the first actuator position of FIG. 8 by first configuring second valve 1b from the second valve position into the first valve position. This is shown in FIG. 11. The valve configurations of FIG. 11 enable compressed gas to flow from reservoir 4 to the pressure chamber 25 of actuator 20. Subsequently configuring first valve 1a from the second valve position to the first valve position as shown in FIG. 8 fully charges actuator chamber 25 and configures actuator 20 into the first actuator position (piston retracted).

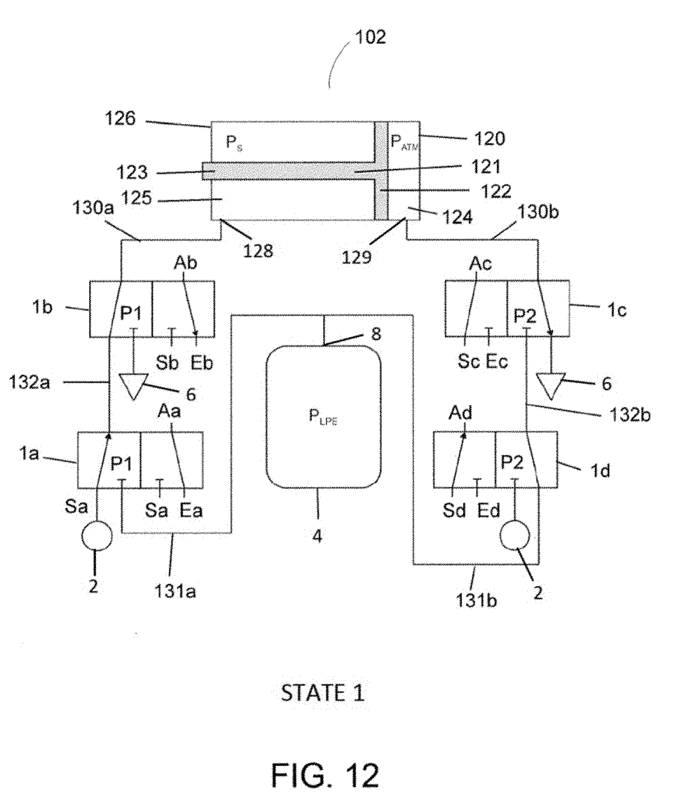

The inventive system and method of temporarily storing a portion of the compressed gas during the discharge process, and subsequently reusing a portion of the stored compressed gas during the following charging portion of the cycle to reduce the consumption of compressed air can be applied in systems employing a double-acting pneumatic actuator. An embodiment method for an exemplary pneumatic circuit including such an actuator 120 is shown in FIGS. 12-19.

A double-acting pneumatic actuator is one that is configured into one of two piston positions (a first actuator position and second actuator position) via pneumatic forces. In the case of linear actuator 120, these two positions can be regarded as retraction and extension of the piston and rod assembly 121 (the assembly 121 comprising piston 122 and rod 123). A double-acting pneumatic actuator 120 is actuated by compressed gas entering in from two compressed gas lines 130a, 130b, wherein compressed gas (typically air) is used to effect both the retraction and extension stroke of piston and rod assembly 121 within housing (shown as a cylinder in the drawings) 126 of actuator 120. The repeated extension and retraction of the piston and rod assembly 121 requires repeated charging and discharging of the compressed gas chambers 124, 125 of the housing 126. It should be noted that the embodied representation of the double-acting pneumatic actuator as a rod-style cylinder is not meant to be limiting. Any double-acting pneumatic actuator can be used in the inventive application.

The method for the temporary storage and re-use of compressed gas during the repeated actuation of a double-acting actuator 120 can advantageously be implemented by using a plurality of standard 3-way valves 1, configured as shown in the exemplary system 102 shown in FIGS. 12-19. For purposes of illustration, the configuration shown depicts actuator 120 for which pressurization of chamber 125 of housing 126 and depressurization of chamber 124 of housing 126 causes retraction of piston and rod assembly 121. Depressurization of chamber 125 of housing 126 along with pressurization of chamber 124 of housing 126 moves piston and rod assembly 121 to the extension configuration.

An embodiment energy saving system and method employs a fluid supply 2, a double-acting actuator 120, a fluid reservoir 4, and first, second, third and fourth three-way control valves 1a, 1b, 1c, 1d. Each three-way control valve employs a supply port S, an exhaust port E, and an outlet port A. Each valve 1a, 1b, 1c, 1d can be configured into a first valve position depicted as P1 and a second valve position depicted as P2. In the first valve position, the supply port S is in fluid communication with the outlet port A, while the exhaust port E is isolated. In the second valve position, the exhaust port E is in fluid communication with the outlet port A, while the supply port is isolated. The double-acting actuator 120 includes at least first and second actuator ports 128, 129, while the reservoir 4 includes at least one fluid port 8.

The ports of each respective component are connected as follows. Outlet port Ab of second valve 1b is connected via line 130a to first actuator port 128 of actuator 120. Supply port Sb of second valve 1b is connected via line 132a to outlet port Aa of first valve 1a. Exhaust port Eb of second valve 1b is connected to exhaust 6. Supply port Sa of first valve 1a is connected to supply 2. Exhaust port Ea of first valve 1a is connected via line 131a to reservoir 4. Outlet port Ac of third valve 1c is connected via line 130b to second actuator port 129 of actuator 120. Supply port Sc of third valve 1c is connected via line 132b to outlet port Ad of fourth valve 1d. Exhaust port Ec of third valve 1c is connected to exhaust 6. Supply port Sd of fourth valve 1d is connected to fluid supply 2. Exhaust port Ed of fourth valve 1d is connected via line 131b to reservoir 4.

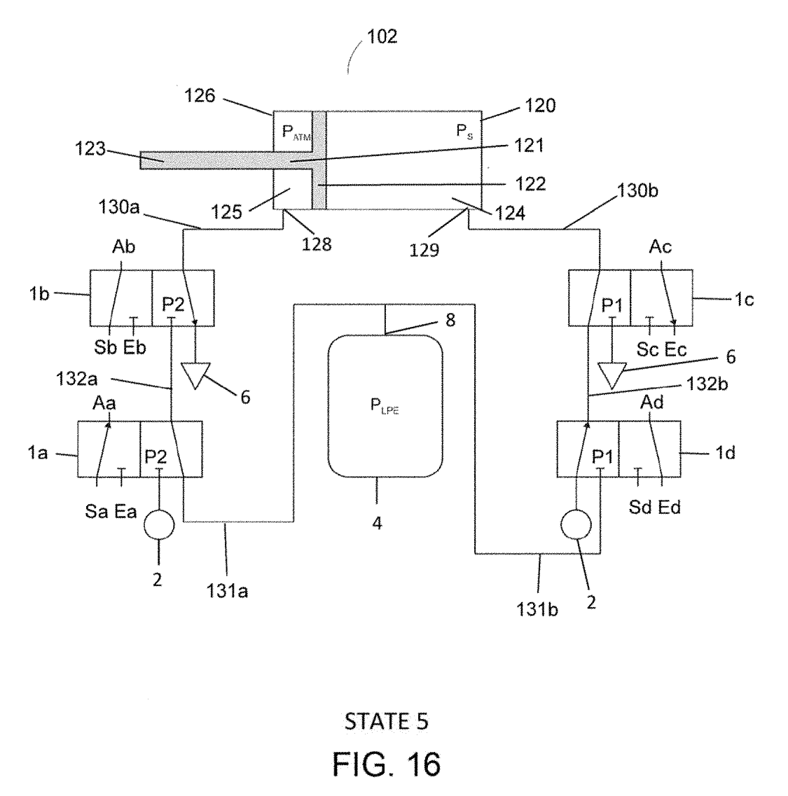

As illustrated in FIG. 12, actuator 120 is configured into a first actuator position when first and second valves 1a, 1b are configured respectively in the first valve position P1, while the third and fourth valves 1c, 1d are configured in the second valve position P2. As illustrated in FIG. 16, actuator 120 is configured into a second actuator position when the first and second valves 1a, 1b are configured respectively in the second valve position P2, while the third and fourth valves 1c, 1d are configured in the first valve position P1.

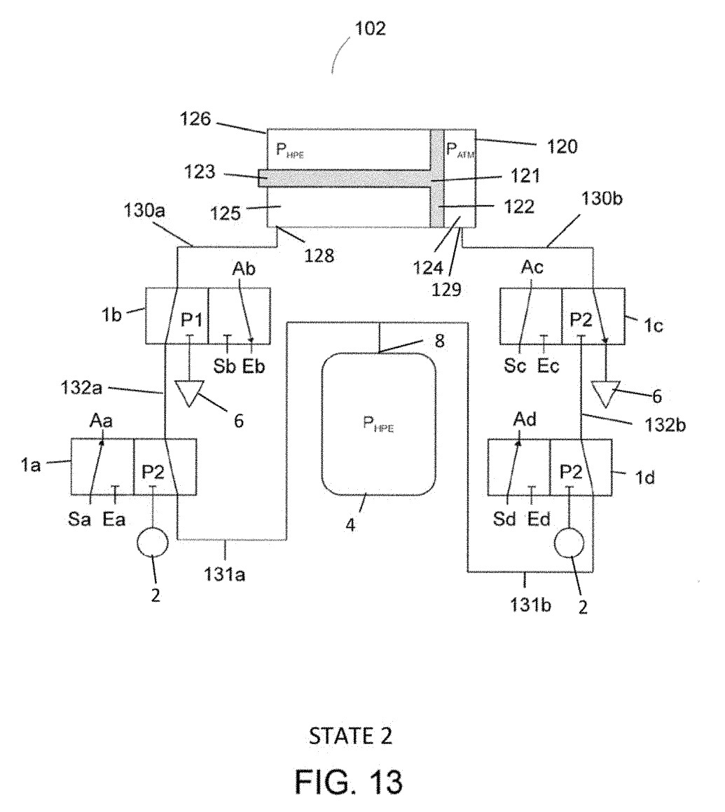

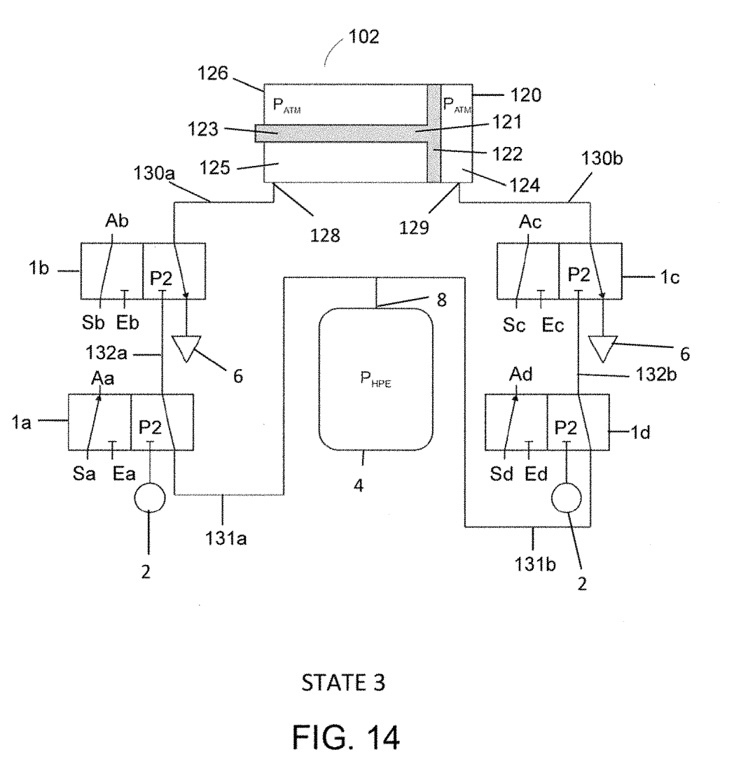

Double-acting cylinder 120 is configured to move from the first actuator position of FIG. 12 and into the second actuator position shown in FIG. 16 by a sequence of valve configurations. In the first configuration (state 1), valve 1a is in the first position, valve 1b is in the first position, valve 1c is in the second position and valve 1d is in the second position. This configuration of valves causes fluid from fluid supply to flow into chamber 125 of actuator 120 via valves 1a, 1b and effect the retraction of piston assembly 121. The second configuration sequence involves maintaining all other valves in the configurations shown in FIG. 12 and configuring first valve 1a from the first valve position and into the second valve position. This action is shown in FIG. 13 and causes compressed gas in chamber 125 to flow from the pressurized chamber 125 of the actuator 120 to reservoir 4 (state 2). In the third configuration sequence, shown in FIG. 14, while maintaining all other valves in the configuration of state 2 (FIG. 13), second valve 1b is configured from the first valve position to the second valve position. This last step discharges the remaining compressed gas in first actuator chamber 125 to exhaust 6 (state 3).

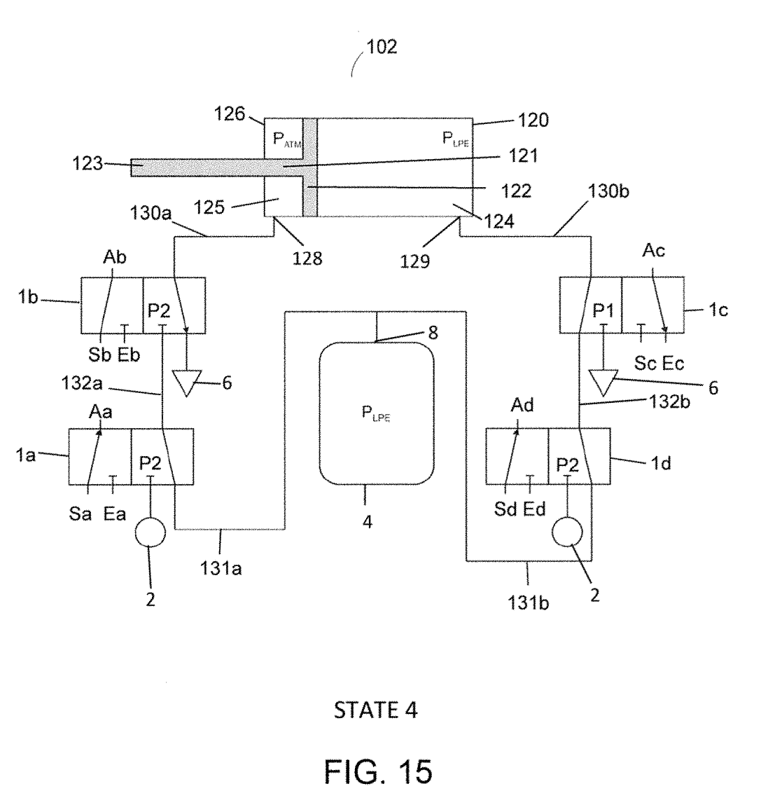

In the fourth configuration sequence, while maintaining all other valves in the configuration of state 3 (FIG. 14), third valve 1c is configured from the second valve position to the first valve position as shown in FIG. 15 (state 4). This causes compressed gas to flow from the reservoir 4 to the second chamber 124 of actuator 120. In the fifth sequence, while maintaining all other valves in their configuration of state 4 shown in FIG. 15, fourth valve 1d is configured from the second valve position to the first valve position to connect to fluid supply 2. This fifth configuration is shown in FIG. 16 and completes the charging process of second actuator chamber 124, and completes the configuring of actuator 120 into the second actuator position (state 5).

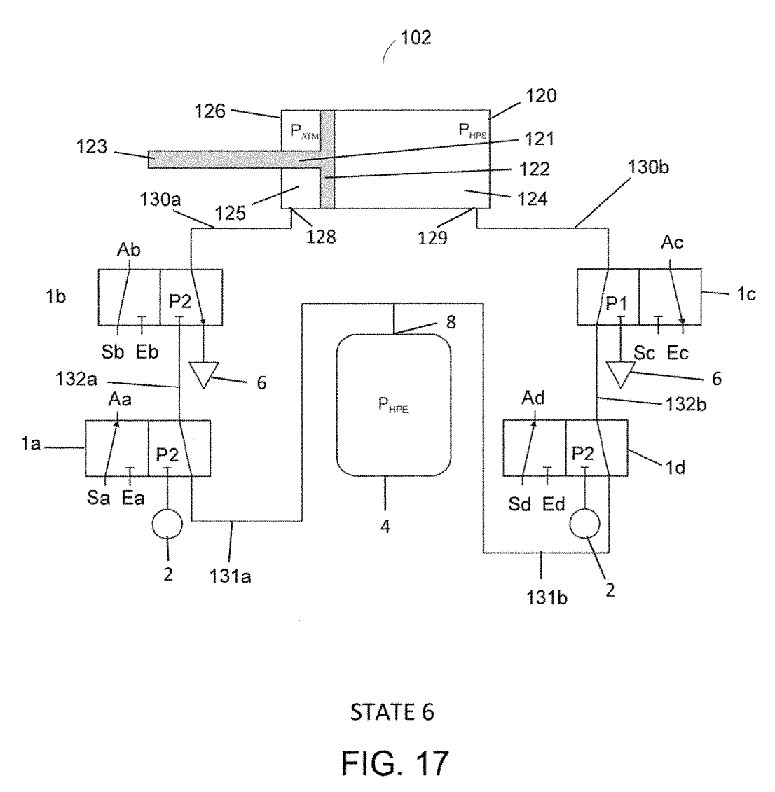

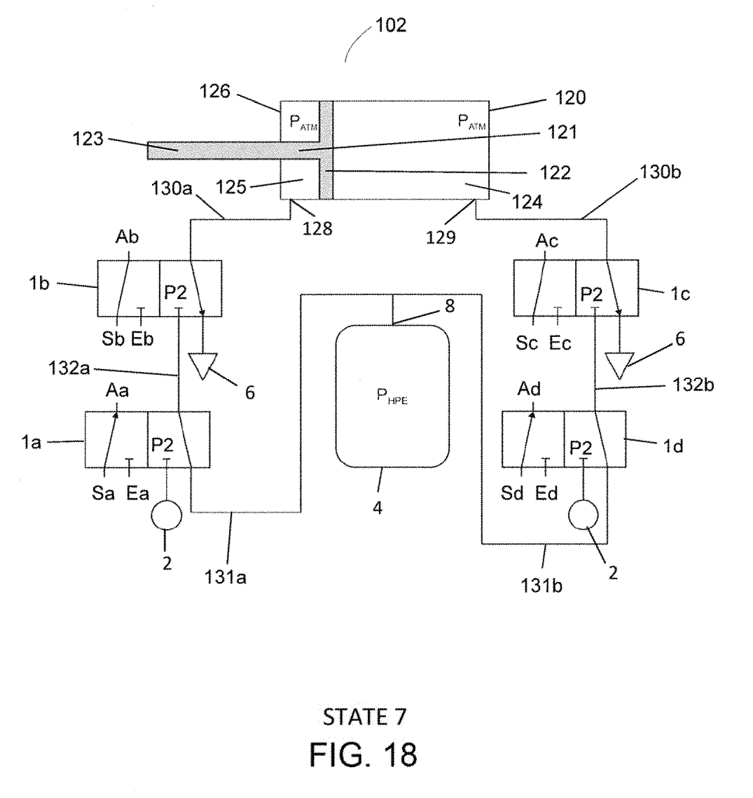

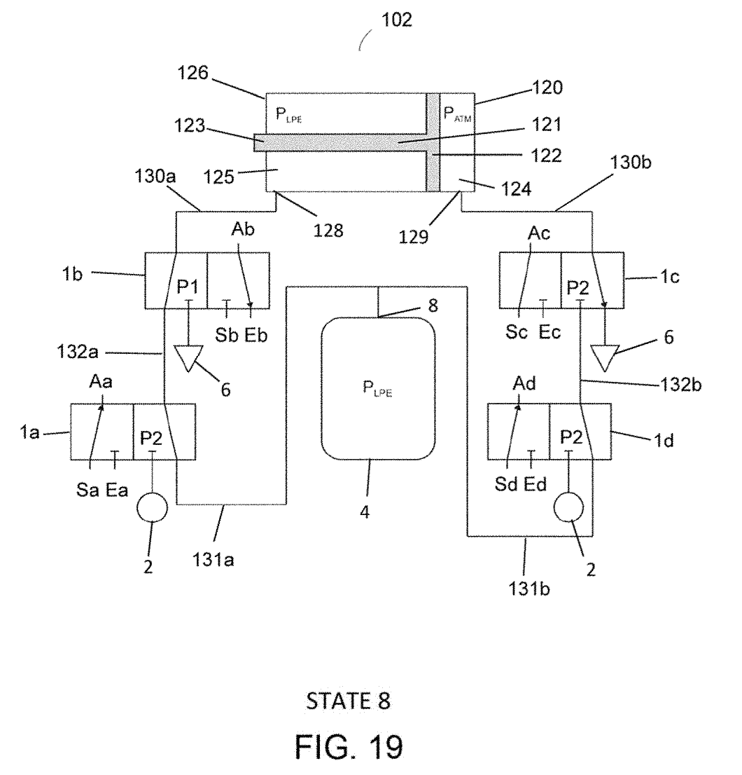

Double-acting cylinder 120 can be configured to move from the second actuator position shown in FIG. 16 and into the original first actuator position shown in FIG. 12 by another series of configuration sequences. In this respect, while maintaining all other valves in their configuration of state 5, fourth valve 1d is configured from the first valve position into the second valve position as depicted in FIG. 17 (state 6). This sixth configuration of valves 1a, 1b, 1c, 1d results in compressed gas flowing from pressurized chamber 124 of actuator 120 to reservoir 4. In the next (seventh) configuration, while maintaining all other valves in their configuration of state 6, third valve 1c is configured from the first valve position to the second valve position as shown in FIG. 18. This configuration allows for the discharge of the remaining compressed gas in second actuator chamber 124 to exhaust (state 7). Once chamber 124 exhausts, then the eighth configuration sequence involves configuring second valve 1b from the second valve position to the first valve position while all other valves are maintained in their configuration shown in FIG. 18. This configuration action is shown in FIG. 19 and causes compressed gas to flow from the reservoir 4 to the chamber 125 of actuator 120 (state 8). Configuring first valve 1a from the second valve position to the first valve position, while maintaining all other valves in their configurations of state 8, as indicated in FIG. 12 completes the charging process of the first actuator chamber and completes the configuring of actuator 120 into the first actuator position.

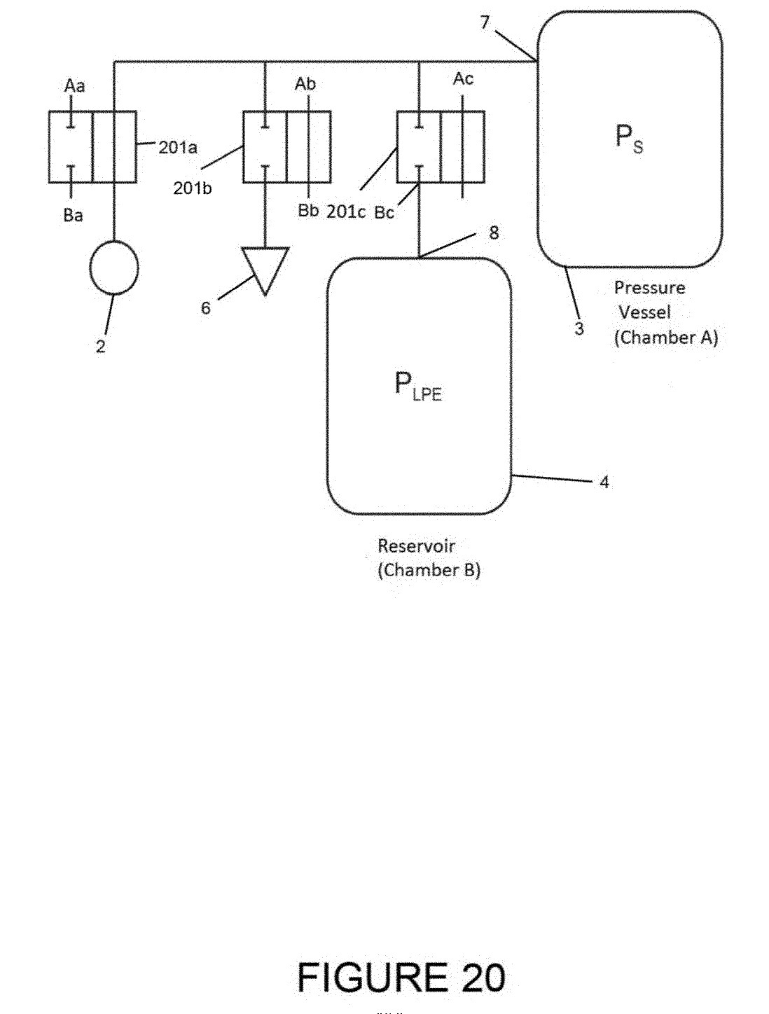

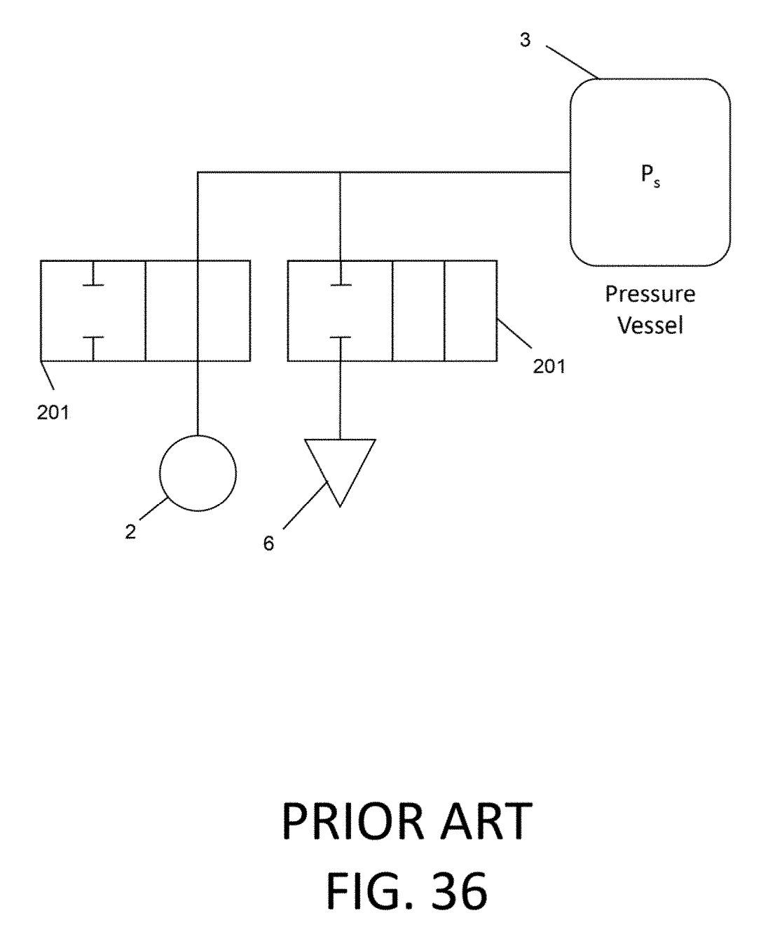

The inventive systems and methods will now be described in the context of their 2-way valve preferred embodiments. FIG. 36 is a schematic diagram of a standard configuration for a working vessel charging via two standard 2-way control valves. The configuration shows the pressurized state of the system. A preferred embodiment of the proposed systems and methods can be implemented by using a plurality of standard 2-way valves 201a, 201b, 201c configured as shown in FIGS. 20-23. As seen in the figures, a 2-way valve can be configured into a first valve position and a second valve position, where in the first valve position the two ports (a first port A and second port B) are in fluid isolation, and where in the second valve position the two ports are in fluid communication.

The embodiment energy saving method of FIGS. 20-23 includes a fluid supply 2, a working vessel 3, a fluid reservoir 4, and first, second, and third 2-way control valves 201a, 201b and 201c. Working vessel 3 and reservoir 4 respectively each include at least one fluid port 7, 8. The respective first ports Aa, Ab, Ac of the first, second, and third valves 201a, 201b, 201c are connected to fluid port 7 of working vessel 3. Second port Ba of first valve 201a is connected to a fluid supply 2. Second port Bb of second valve 201b is connected to exhaust 6. Second port Bc of third valve 201c is connected to fluid port 8 of reservoir 4.

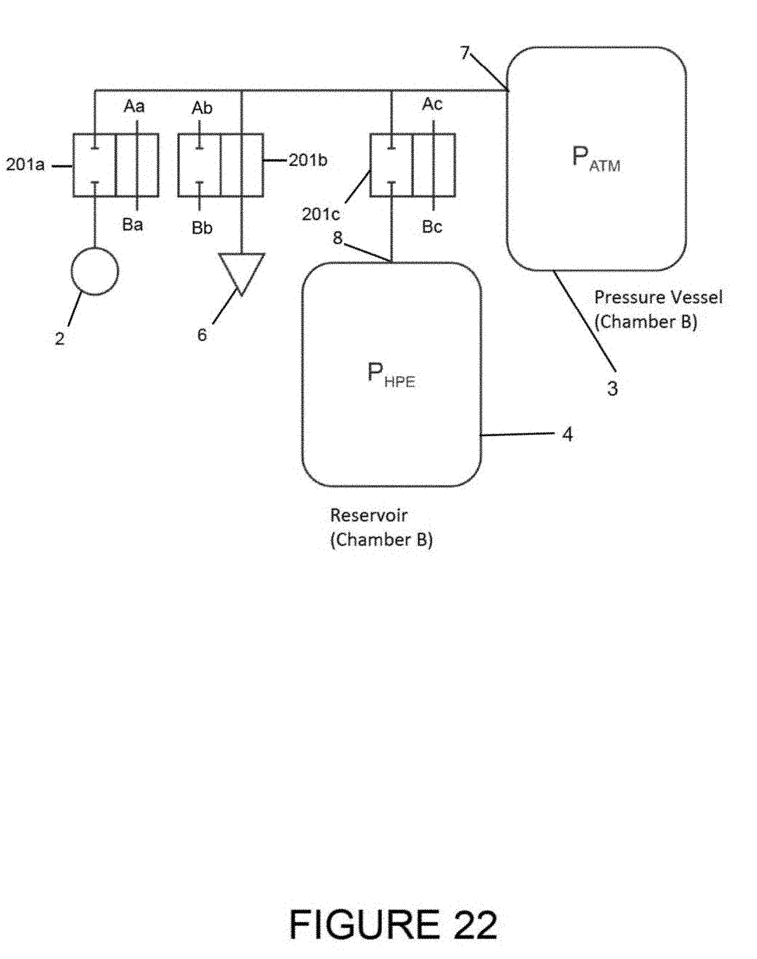

As illustrated in FIG. 20, working vessel 3 is maintained in a charged state when first valve 201a is configured in the second valve position (i.e., fluid communication), while the second and third valves 201b, 201c are configured respectively in the first valve position (i.e., fluid isolation). As illustrated in FIG. 22, working vessel 3 is maintained in a discharged state when first valve 201a is configured in the first valve position, second valve 201b is in the second valve position, and third valve 201c in the first valve position.

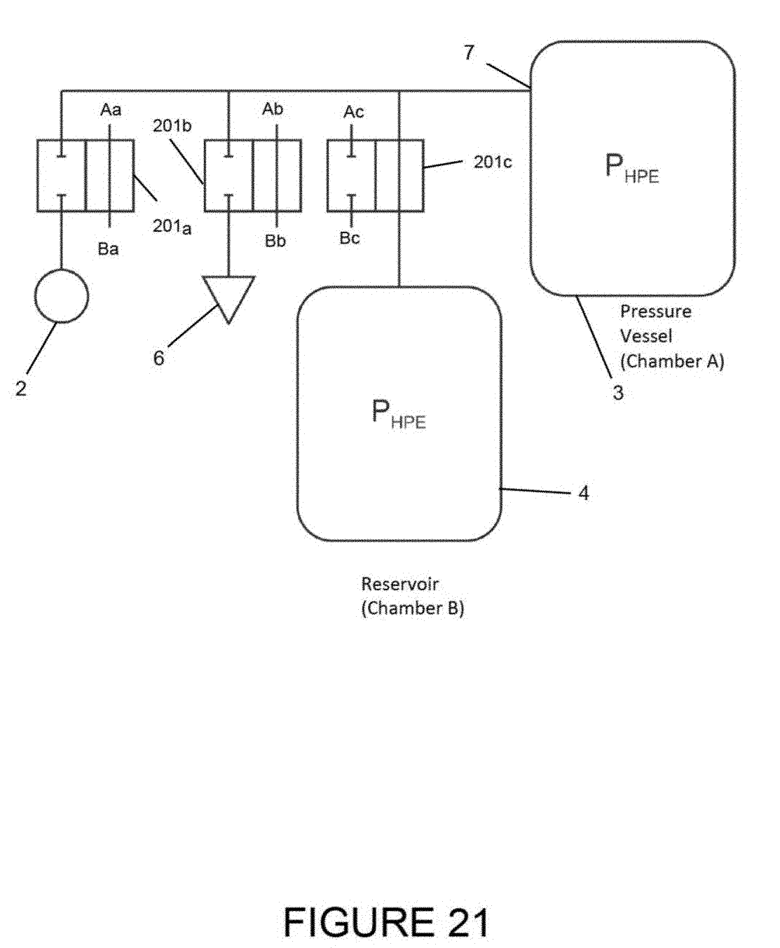

Working vessel 3 is configured from the charged state FIG. 20 into the discharged state of FIG. 22 by: configuring first valve 201a from the second valve position into the first valve position and subsequently configuring third valve 201c from the first valve position to the second valve position. These configurations are shown in FIG. 21. The valve configurations of FIG. 21 enable compressed gas to flow from working vessel 3 to reservoir 4. After achieving the configuration of FIG. 21, third valve 201c is configured from the second valve position to the first valve position and then second valve 201b is configured from the first valve position to the second valve position. These steps are shown in FIG. 22. The configurations of FIG. 22 discharge the remaining compressed gas from the pressure vessel to exhaust.

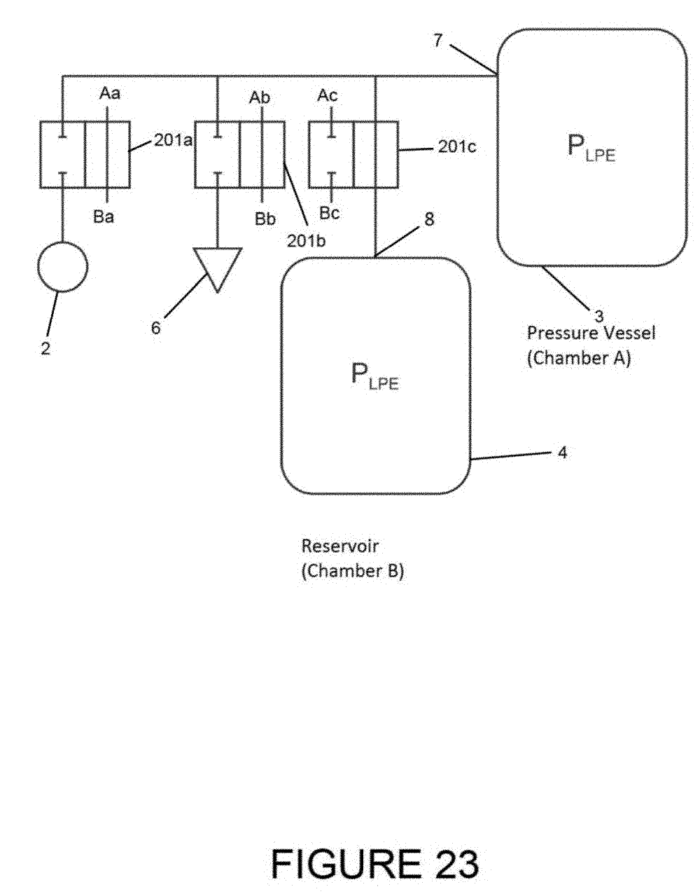

Working vessel 3 is configured from the discharged state of FIG. 22 to the charged state shown in FIG. 20 by configuring second valve 201b from the second valve position to the first valve position and subsequently configuring third valve 201c from the first valve position to the second valve position as shown in FIG. 23. These valve configurations of FIG. 23 enable compressed gas to flow from reservoir 4 to pressure vessel 3. Next, third valve 201c is configured from the second valve position to the first valve position and first valve 201a is configured from the first valve position to the second valve position. These configurations are shown in FIG. 20 and complete the charging process of the pressure vessel.

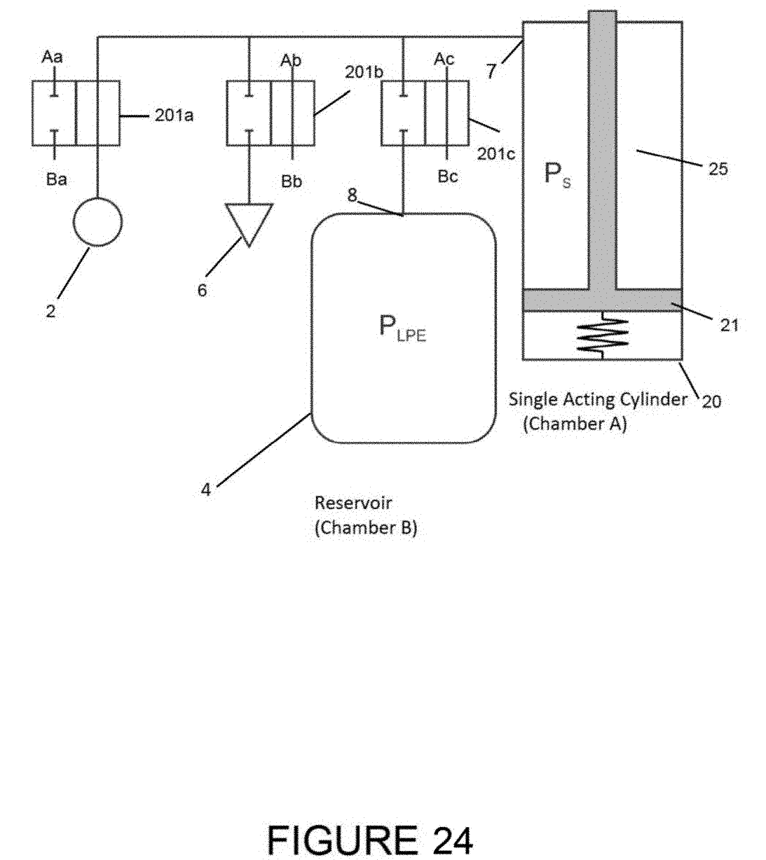

In a further embodiment, the method for the temporary storage and re-use of compressed gas can be employed to effect the repeated actuation of a single-acting actuator 20 (e.g., the fluid chamber of which is a working vessel) by using a plurality of standard 2-way valves 201a, 201b, 201c. This method is shown in FIGS. 24-27. The embodiment energy saving system and method employs a fluid supply 2, a single-acting actuator 20, a fluid reservoir 4 and first, second, and third 2-way control valves 201a, 201b, 201c. The single-acting actuator 20 and reservoir 4 respectively include at least one fluid port 7, 8. The respective first ports Aa, Ab, Ac of the first, second, and third valves 201a, 201b, 201c are connected to fluid port 7 of actuator 20. Second port Ba of first valve 201a is connected to supply 2. Second port Bb of second valve 201b is connected to exhaust. Second port Bc of third valve 201c is connected to fluid port 8 of reservoir 4.

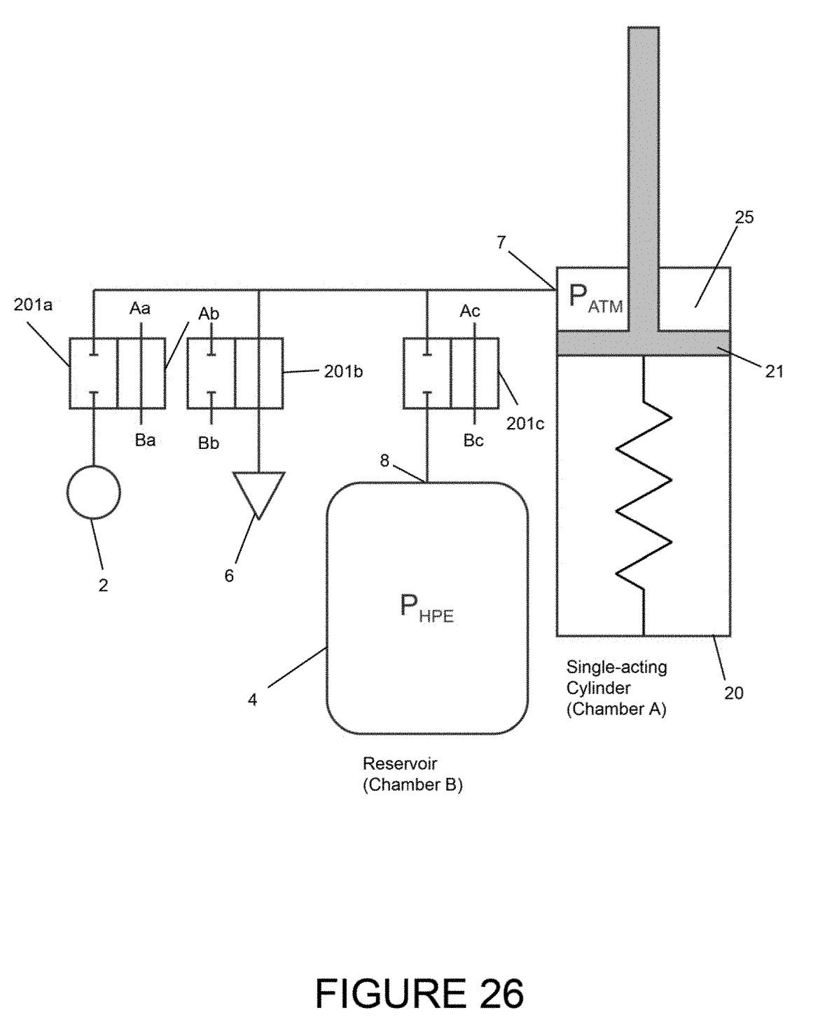

As illustrated in FIG. 24, actuator 20 is configured into a first actuator position when first valve 201a is configured in the second valve position (i.e., fluid communication), while second and third valves 201b, 201c are configured respectively in the first valve position (i.e., fluid isolation). As illustrated in FIG. 26, actuator 20 is configured into a second actuator position when first valve 201a is configured in the first valve position, second valve 201b is configured in the second valve position and third valve 201c in the first valve position.

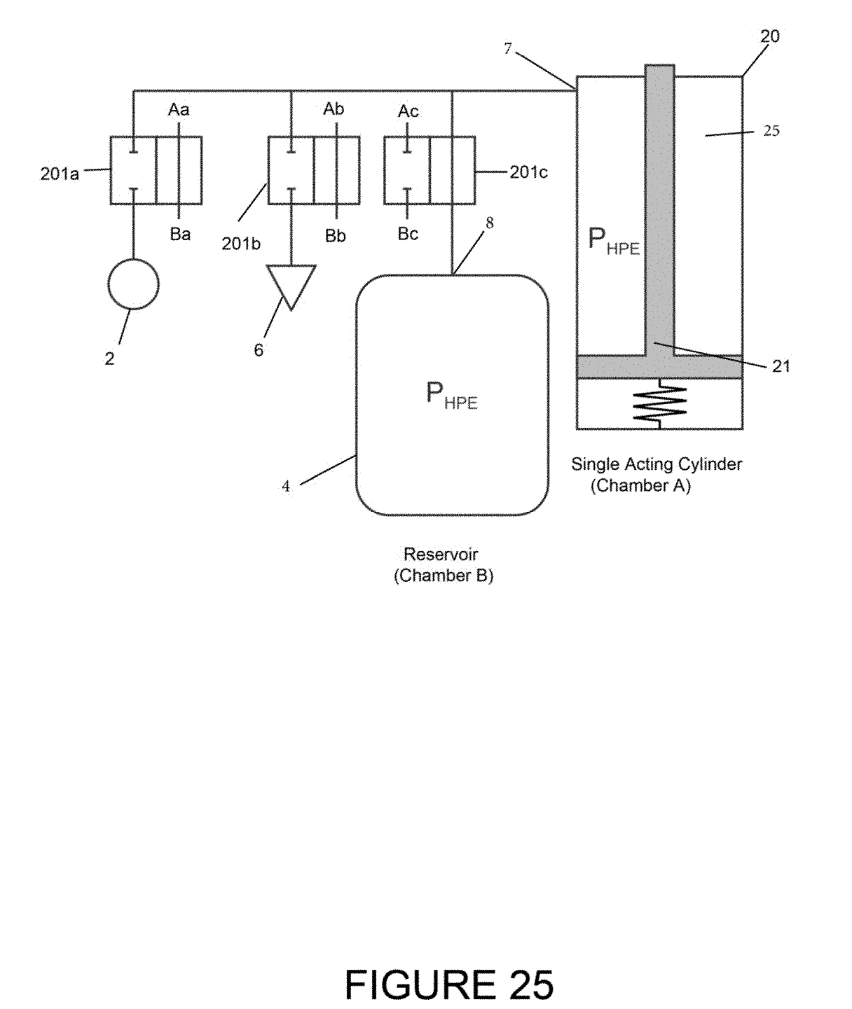

Single-acting cylinder 20 is configured to move from the first actuator position shown in FIG. 24 into the second actuator position shown in FIG. 26 by undergoing a first and second configuration sequence. The first configuration sequence involves maintaining second valve 201b in the first configuration and configuring first valve 201a from the second valve position into the first valve position and then subsequently configuring third valve 201c from the first valve position to the second valve position. This configuration of valves is shown FIG. 25 and enables compressed gas to flow from the pressurized side of the actuator 20 to reservoir 4. The second configuration sequence involves maintaining first valve 201a in the first configuration and configuring third valve 201c from the second valve position to the first valve position and subsequently configuring second valve 201b from the first valve position to the second valve position. These latter configurations are shown in FIG. 26 and result in the discharge of the remaining compressed gas in the actuator chamber 25 to exhaust, completing the discharging process of actuator chamber 25 and completing the configuring of actuator 20 into the second actuator position (shown in this embodiment as piston extended).

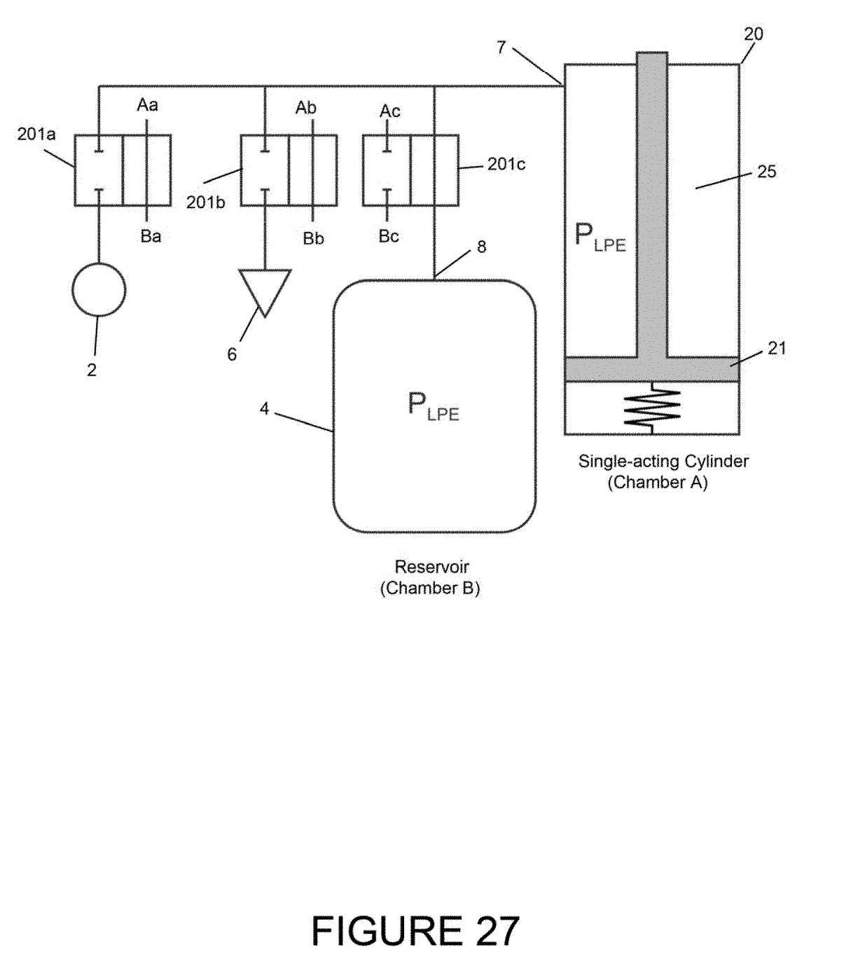

Actuator 20 is configured to move from the second actuator position of FIG. 26 and on into the first actuator position of FIG. 24 by undergoing two further configuration sequences (the third and fourth configuration sequences). The third configuration sequence involves maintaining first valve 201a in the first position while configuring second valve 201b from the second valve position to the first valve position and subsequently configuring third valve 201c from the first valve position to the second valve position. These configurations are shown in FIG. 27. The configurations of FIG. 27 enables compressed gas to flow from reservoir 4 to actuator chamber 25. After completing the third configuration sequence, the fourth configuration sequence proceeds. In this fourth configuration sequence second valve 201b is maintained in the first valve position while configuring third valve 201c from the second valve position to the first valve position and subsequently configuring first valve 201a from the first valve position to the second valve position as shown in FIG. 24. The configurations of FIG. 24 allow for the completion of the charging process of actuator chamber 25 resulting in the movement of piston and rod assembly 21 into the retracted position, which is the first actuator position.

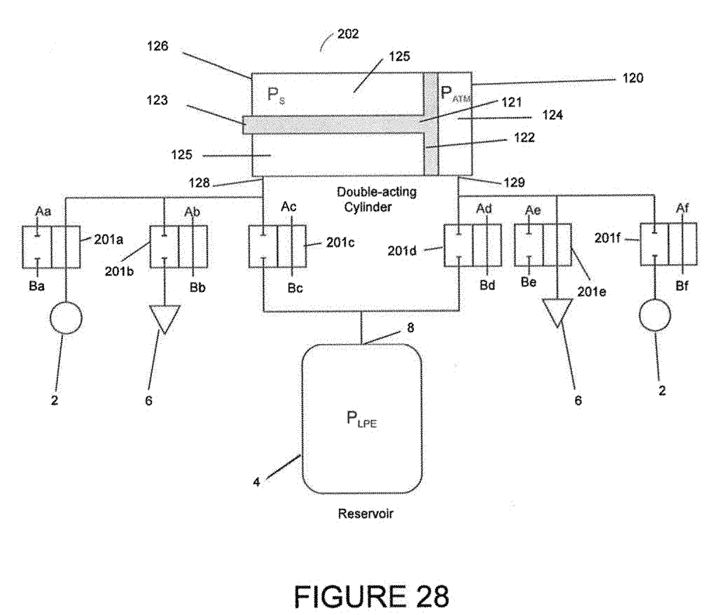

The method for the temporary storage and re-use of compressed gas during the repeated actuation of a double-acting actuator 120 can advantageously implemented by using a plurality of standard 2-way valves 201a, 201b, 201c, 201d, 201e, 201f configured as shown in the exemplary system 202 shown in FIGS. 28-35. For purposes of illustration, the configuration shown depicts actuator 120 for which pressurization of chamber 125 of housing 126 and depressurization of chamber 124 of housing 126 causes retraction of piston and rod assembly 121. Depressurization of chamber 125 of housing 126 along with pressurization of chamber 124 of housing 126 moves piston and rod assembly 121 to the extension configuration. It should again be noted that the embodied representation of the double-acting pneumatic actuator as a rod-style cylinder is not meant to be limiting. Any double-acting pneumatic actuator can be used in the inventive application.

2-way valves 201a, 201b, 201c, 201d, 201e, 201f are configured as shown in the exemplary system 202 shown in FIGS. 28-35. The 2-way valve embodiment of the energy saving system and method employs a fluid supply 2, a double-acting actuator 120, a fluid reservoir 4, and first, second, third, fourth, fifth, and sixth 2-way control valves 201a, 201b, 201c, 201d, 201e, 201f. Double-acting actuator 120 includes a first actuator port 128 and second actuator port 129. Reservoir 4 includes at least one fluid port 8. The respective first ports Aa, Ab, Ac of the first, second, and third valves 201a, 201b, 201c are connected to first port 128 of actuator 120, which comprises two chambers, 124, 125. The respective first ports Ad, Ae, Af of the fourth, fifth, and sixth valves 201d, 201e, 201f are connected to second port 129 of actuator 120. The second ports of first and sixth valves 201a, 201f are connected to fluid supply 2. The second ports of second and fifth valves 201b, 201c are connected to exhaust. The second ports of third and fourth valves 201c, 201d are connected to fluid port 8 of reservoir 4.

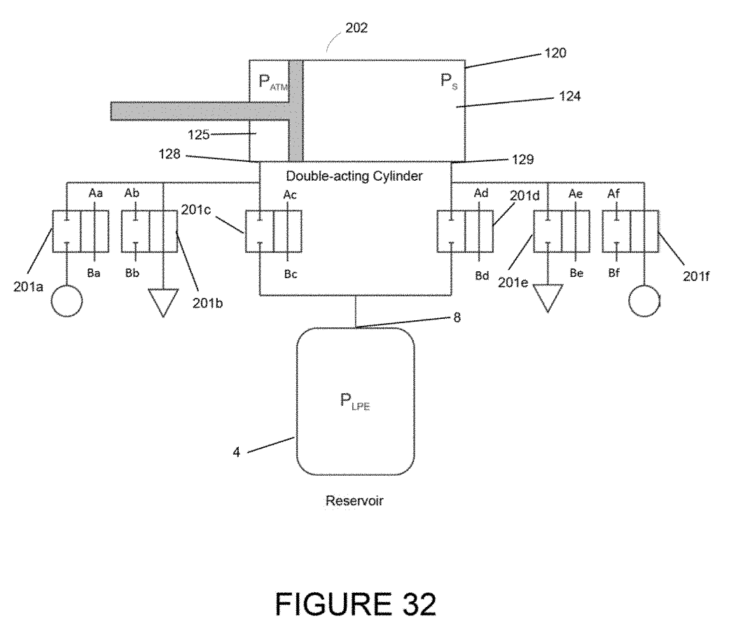

As illustrated in FIG. 28, actuator 120 is configured into a first actuator position (piston assembly retracted) when valves 201b, 201c, 201d, 201f are configured respectively in the first valve position (i.e., fluid isolation) and first and fifth valves 201a, 201e are configured respectively in the second valve position (i.e., fluid communication). As illustrated in FIG. 32, actuator 120 is configured into a second actuator position (chamber 124 fully charged and piston 122 assembly fully extended) when the second and sixth valves 201b, 201f are configured respectively in the second valve position, while the remaining valves 201a, 201c, 201d, 201e are configured respectively in the first valve position.

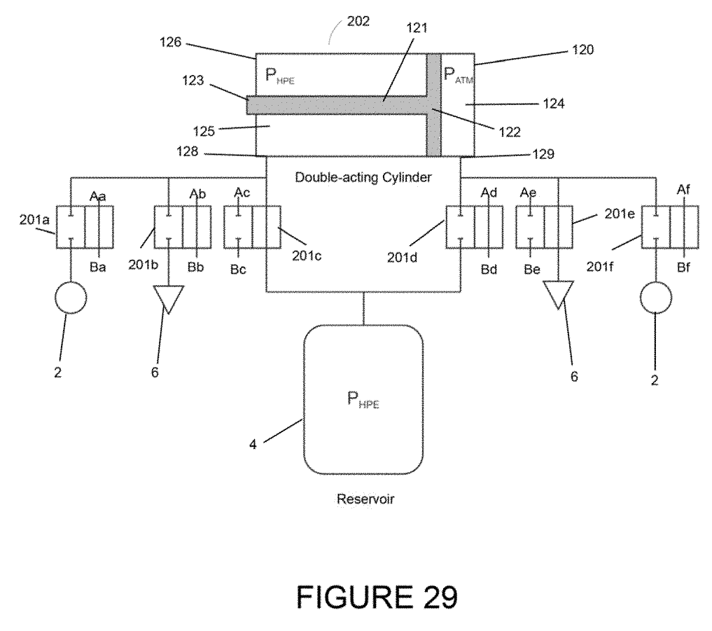

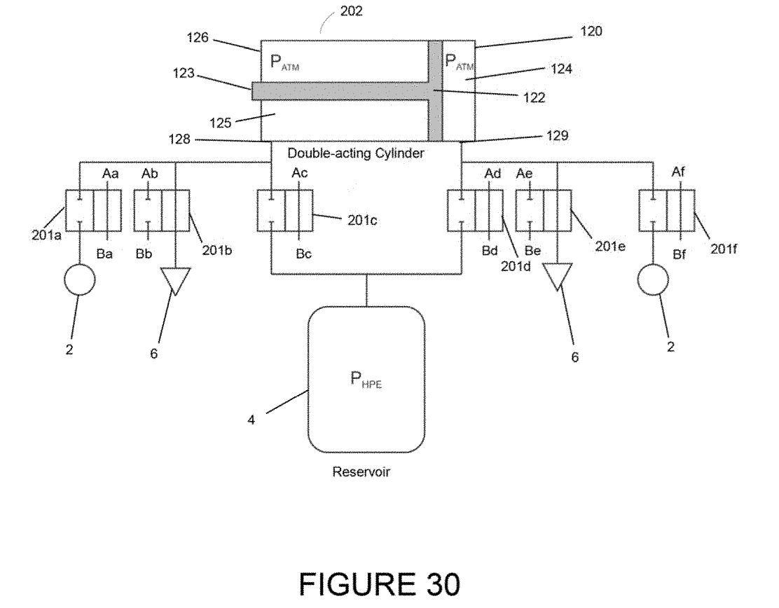

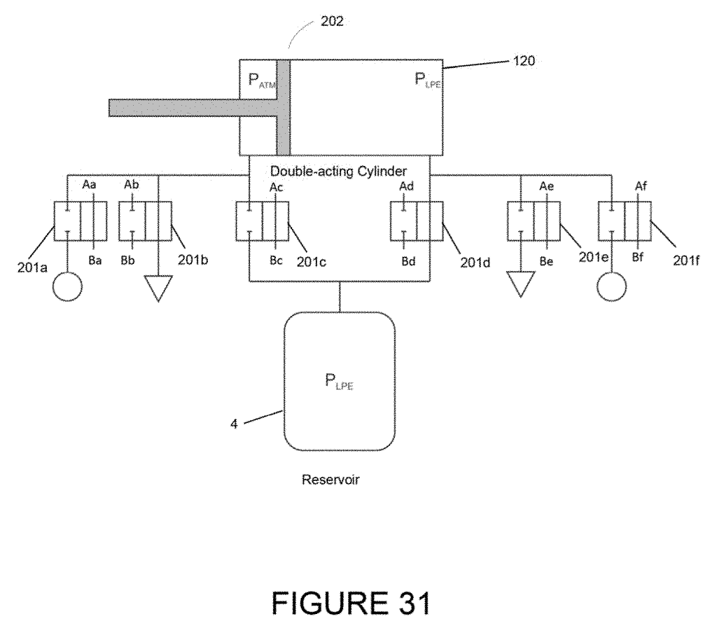

Double-acting cylinder 120 is configured to move from the first actuator position of FIG. 28 and into the second actuator position of FIG. 32 by manipulating the valves through a series of configuration sequences described as follows. In the first configuration sequence, while maintaining all other valves in the valve positions shown in FIG. 28, first valve 201a is configured from the second valve position into the first valve position and then third valve 201c is configured from the first valve position to the second valve position. This completed configuration sequence is shown in FIG. 29 and enables compressed gas to flow from chamber 125 of actuator 120 to reservoir 4. In the second configuration sequence, while maintaining all other valves in the valve positions shown in FIG. 29, third valve 201c is configured from the second valve position to the first valve position and then subsequently second valve 201b is configured from the first valve position to the second valve position. This completed configuration sequence is shown in FIG. 30 and discharges the remaining compressed gas in the first actuator chamber 125 to exhaust. In the third configuration sequence, while maintaining all other valves in the valve positions shown in FIG. 30, fifth valve 201e is configured from the second valve position to the first valve position and then subsequently fourth valve 201d is configured from the first valve position to the second valve position. This completed configuration sequence is shown in FIG. 31 and enables compressed gas to flow from reservoir 4 to the chamber 124 of actuator 120. In the fourth configuration sequence, while maintaining all other valves in the valve positions shown in FIG. 31, fourth valve 201d is configured from the second valve position to the first valve position and then sixth valve 201f is configured from the first valve position to the second valve position. This completed configuration sequence is shown in FIG. 32 and completes the charging process of second actuator chamber 124 and completes the configuring of actuator 120 into the second actuator position.

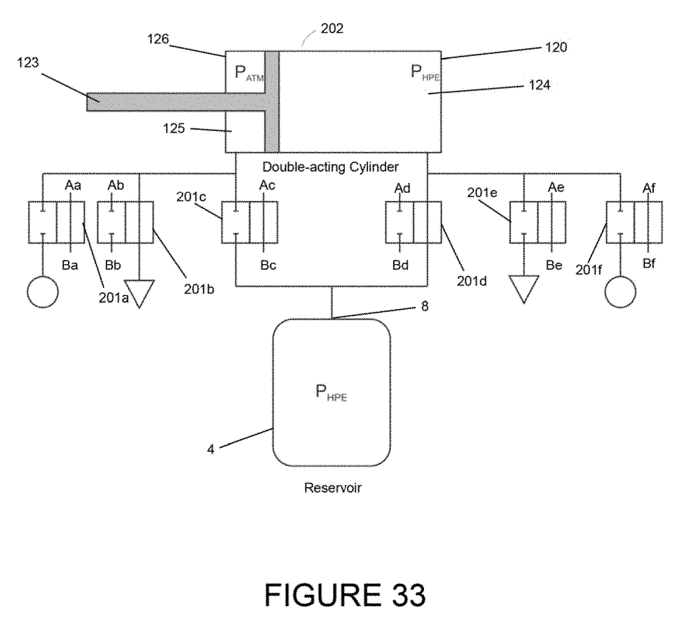

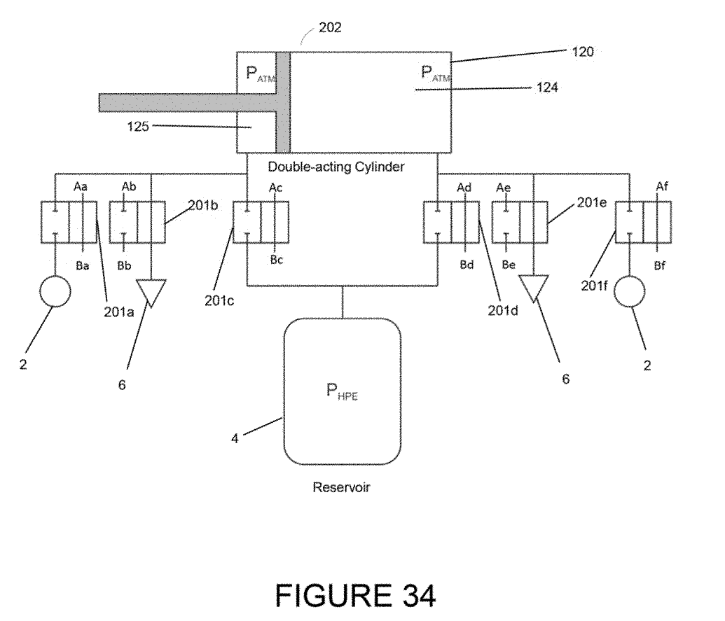

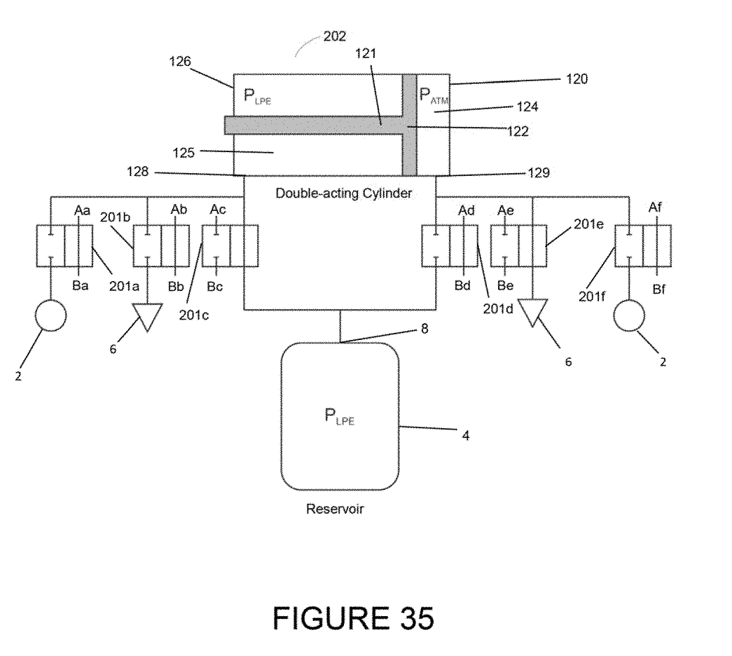

Double-acting cylinder 120 is configured to move from the second actuator position of FIG. 32 into the first actuator position of FIG. 28 by manipulating the valves through a series of configuration sequences described as follows. In the fifth configuration sequence, while maintaining all other valves in the valve positions of FIG. 32, sixth valve 201f is configured from the second valve position into the first valve position and then fourth valve 201d is configured from the first valve position to the second valve position. This completed sequence is shown in FIG. 33 and enables compressed gas to flow from the pressurized chamber 124 to reservoir 4. In the sixth configuration sequence, while all other valves are maintained in their positions shown in FIG. 33, fourth valve 201d is configured from the second valve position to the first valve position and then fifth valve 201e is configured from the first valve position to the second valve position. This completed sequence is shown in FIG. 34 and discharges the remaining compressed gas in the second actuator chamber 124 to exhaust. In the seventh configuration sequence, while all other valves are maintained in the positions shown in FIG. 34, second valve 201b is configured from the second valve position to the first valve position and then third valve 201c is configured from the first valve position to the second valve position. This completed configuration sequence is shown in FIG. 35 and enables compressed gas to flow from reservoir 4 to first chamber 125 of actuator 120. In the eighth configuration sequence, while maintaining all other valves in their valve position of FIG. 35, third valve 201c is configured from the second valve position to the first valve position and then first valve 201a is configured from the first valve position to the second valve position. This completed sequence results in the valve positions of shown in FIG. 28 and completes the charging process of first actuator chamber 125 and also completes the configuring of actuator 120 into the first actuator position.

In any of the systems and methods described and shown in this application reservoir 4 can include a pressure sensor 60 and controller 50 to control timing of the periods during which fluid is moving into or out of the reservoir (also known as the “dwell” periods). This option is shown in FIGS. 4-7. The reservoir may also include additively or separately, a ball valve to empty the reservoirs if needed. Any of the working vessels can include one or more pressure sensors 60 and the pressure equilibration process can be regulated such that equilibration process is terminated when the rate of change of pressure falls below a predetermined threshold.

For purposes of satisfying the required dwell times, an embodiment system may include a controller 50 programmed to cause the valve to stop and remain in a configuration sequence in which fluid flows into or out of the reservoir for a specified period of time. The specified period of time can vary among configuration sequences during which fluid moves into the reservoir and fluid moves out of the reservoir. In one embodiment, the controller 50 determines the specified period of time for which the system remains in a configuration sequence based upon an input of the amount of time necessary for pressure in a working vessel (or chamber thereof) and reservoir 4 to equilibrate. In another embodiment system, the controller 50 will determine the specified period of time for which the valve remains in a configuration sequence using as an input the length of time required for the pressure difference between the working vessel 3 and reservoir 4 to fall below a predetermined threshold.

While exemplary embodiments are described herein, it will be understood that various modifications to the systems and methods described can be made without departing from the scope of the invention. The foregoing detailed description has been given for clearness of understanding only, and no unnecessary limitations should be understood therefrom, as modifications will be obvious to those skilled in the art.

What is claimed is:

1. A method for charging and discharging a working vessel in a pneumatic system, the method comprising:
providing:
a first 2-way control valve, a second 2-way control valve and a third 2-way control valve in fluid communication with each other; a) each control valve including a first port and a second port and capable of being configured in a first or second valve position in which in the first position the first and second ports are isolated from each other and in the second position the first and second ports are in fluid communication; b) the first ports of the first, second and third control valves being in fluid communication with each other; c) the second port of the first control valve being fluidly connected to a fluid supply; and d) the second port of the second control valve being fluidly connected to an exhaust; and
a fluid reservoir including a fluid port in fluid communication with the second port of the third control valve; and
a working vessel including a fluid port in fluid communication with the first ports of the first, second and the third control valves; and
configuring the first control valve and second control valve according to the following configurations:
A. configuring the second control valve into the first position, the third control valve into the first position and then the first control valve into the second position, so as to cause fluid from the fluid supply to flow into the working vessel;
B. after configuration step A, maintaining the second control valve in the first position, configuring the first control valve into the first position and then configuring the third control valve into the second position so as to cause fluid to flow from the working vessel to the reservoir;
C. after configuration step B, maintaining the first valve in the first position, configuring the third control into the first position and then configuring the second valve into the second position so as to cause fluid to flow from the working vessel to exhaust and the fluid in the reservoir to be reserved;
D. after configuration step C, maintaining the first valve in the first position, configuring the second control valve into the first position and then configuring the third control valve into the second position so as to cause the reserved fluid to flow from the reservoir to the working vessel; and
E. after configuration step D, maintaining the second control valve in the first position, configuring the third control valve into the first position and then configuring the first control valve into the second position so as to cause fluid to flow from the fluid supply to the working vessel.

2. The method of claim 1 wherein the method further includes:
providing a pressure sensor in electrical communication with a controller, the pressure sensor being located in fluid communication with the reservoir;
sensing the pressure in the reservoir during any of steps A through E; and
controlling timing of the configurations of any of the first control valve, the second control valve or the third control valve in any of steps A through E based upon the sensing of pressure in the reservoir.

3. The method of claim 1 wherein the method further includes:
providing a first pressure sensor and a second pressure sensor in electrical communication with a controller, the first pressure sensor being in fluid communication with the reservoir and the second pressure sensor being in fluid communication with the working vessel;
sensing the pressure in the reservoir and in the working vessel during any of steps A through E; and
controlling timing of the configurations of any of the first control valve, the second control valve or the third control valve in any of steps A through E based upon a comparison of pressures sensed by the first and second pressure sensors.

4. The method of claim 1 wherein the working vessel is the fluid chamber of a single-acting actuator and:
the single-acting actuator is placed in a first actuator position when the first, second and third control valves are configured in accordance with configuration step A and a second actuator position when the first, second and third control valves are configured in accordance with configuration step C.

5. A method for pneumatically actuating a double-acting actuator, the method comprising:
providing:
a first 2-way control valve, a second 2-way control valve and a third 2-way control valve in fluid communication with each other and a fourth 2-way control valve, a fifth 2-way control valve and a sixth 2-way control valve in fluid communication with each other: a) each control valve including a first port and a second port and capable of being configured in a first or second valve position in which in the first position the first and second ports are isolated from each other and in the second position the first and second ports are in fluid communication with each other; b) the first ports of the first, second and third control valves being in fluid communication with each other; c) the first ports of the fourth, fifth and sixth control valves being in fluid communication with each other; d) the second ports of the first and sixth control valves being connected to a fluid supply; and e) the second ports of the second and fifth control valves being connected to an exhaust; and
a reservoir including a fluid port in fluid communication with the second ports of the third and fourth control valves;
a double-acting actuator including a first chamber with a first fluid port in fluid communication with the first ports of the first, second and third control valves and a second chamber with a second fluid port in fluid communication with the first ports of the fourth, fifth and sixth control valves; and
configuring the first through sixth control valves according to the following configuration sequences:
A. configuring the second, third, fourth and sixth control valves into the first position and the first control valve and the fifth control valve into the second position so as to cause fluid from the fluid supply to flow into the first chamber of the double-acting actuator and the second chamber of the double-acting actuator to be in fluid communication with exhaust through the fifth control valve;
B. after configuration step A, maintaining the second, fourth, fifth and sixth control valves in their configurations of step A, configuring the first control valve into the first position and then configuring the third control valve into the second position so as to cause fluid to flow from the first chamber to the reservoir;
C. after configuration step B, maintaining the first, fourth, fifth and sixth control valves in their configurations of step B, configuring the third control valve into the first position and then configuring the second control valve into the second position, so as to cause fluid to flow from the first chamber to exhaust via the second control valve and the fluid in the reservoir to be reserved;
D. after configuration step C, maintaining the first, second, third and sixth control valves in the configurations of step C, configuring the fifth control valve into the first position and then configuring the fourth control valve into the second position so as to cause the reserved fluid in the reservoir to flow from the reservoir the second chamber of the double-acting actuator; and
E. after configuration step D, maintaining the first, second, third and fifth control valves in their configurations of step D, configuring the fourth control valve into the first position and then configuring the sixth control valve into the second position so as to cause fluid to flow from the fluid supply to the second chamber of the double-acting actuator.

6. The method of claim 5 wherein the first through sixth control valves are further configured according to the following configuration sequences:
F. after configuration step E, maintaining the first, second, third and fifth control valves in their configurations of step E, configuring the sixth control valve into the first position and then configuring the fourth control valve into the second position so as to cause fluid to flow from the second chamber to the reservoir;
G. after configuration step F, maintaining the first, second, third and sixth control valves in their configurations of step F, configuring the fourth control valve into the first position and then configuring the fifth control valve into the second position so as to cause fluid to flow from the second chamber to exhaust and the fluid in the reservoir to be reserved;
H. after configuration step G, maintaining the first, fourth, fifth and sixth control valves in their configurations of step G, configuring the second control valve into the first position and then configuring the third control valve into the second position so as to cause fluid to flow from the reservoir to the first chamber; and
I. after configuration step H, maintaining the second, fourth, fifth and sixth control valves in their configurations of step H, configuring the third control valve into the first position and then configuring the first control valve into the second position so as to cause fluid from the fluid supply to flow into the first chamber of the double-acting actuator.

7. The method of claim 6 wherein the method further includes:
providing at least two pressure sensors in electrical communication with a controller, whereby one of the at least two pressure sensors is in fluid communication with the reservoir and another of the at least two pressure sensors is in fluid communication with at least one of the chambers of the double-acting actuator;
sensing the pressure in the reservoir and in the at least one of the chambers of the double-acting actuator during any of steps A through H; and
controlling timing of the configurations of any of the first control valve, the second control valve, the third control valve, the fourth control valve, the fifth control valve, or the sixth control valve in any of steps A through E based upon a comparison of pressures sensed by the sensor in fluid communication with the reservoir and the sensor in fluid communication with one of the chambers of the double-acting actuator.

8. A method for charging and discharging a working vessel in a pneumatic system, the method comprising:
providing:
a first three-way control valve in fluid communication with a second three-way control valve: a) each control valve including a supply port, an exhaust port and an outlet port and capable of being configured in a first and second position in which in the first position the supply port is in fluid communication with the outlet port and the exhaust port is in fluid isolation and in the second position the exhaust port is in fluid communication with the outlet port and the supply port is in fluid isolation; b) the outlet port of the first control valve being in fluid communication with the supply port of the second control valve; and c) the supply port of the first control valve being connected to a fluid supply and the exhaust port of the second control valve being connected to an exhaust; and
a fluid reservoir including a fluid port in fluid communication with the exhaust port of the first three-way control valve; and
a working vessel including a fluid port in fluid communication with the outlet port of the second three-way control valve; and
configuring the first control valve and second control valve according to the following sequence:
A. configuring the first control valve into the first position and the second control valve into the first position so as to cause fluid from the fluid supply to flow into the working vessel;
B. after configuration step A, configuring the first control valve into the second position while maintaining the second control valve in the first position so as to cause fluid to flow from the working vessel to the reservoir;
C. after configuration step B, configuring the second control valve into the second position and maintaining the first valve in the second position so as to cause fluid to flow from the working vessel to exhaust and the fluid in the reservoir to be reserved;
D. after configuration step C, configuring the second control valve into the first position and maintaining the first valve in the second position so as to cause the reserved fluid to flow from the reservoir to the working vessel; and
E. after configuration step D, configuring the first control valve into the first position and maintaining the second control valve in the first position so as to cause fluid from the fluid supply to flow to the working vessel.

9. The method of claim 8 wherein the method further includes:
providing a pressure sensor in electrical communication with a controller in the reservoir, the pressure sensor being in fluid communication with the reservoir;
sensing the pressure in the reservoir at one or more time intervals during steps A through E; and
controlling timing of the configurations of any of the first control valve or the second control valve in any of steps A through E based upon a rate of change of pressure in the reservoir.

10. The method of claim 8 wherein the method further includes:
providing a first pressure sensor and a second pressure sensor in electrical communication with a controller, the first pressure sensor being in fluid communication with the reservoir and the second pressure sensor being in fluid communication with the working vessel;
sensing the pressure in the reservoir and in the working vessel during any of steps A through E; and
controlling timing of the configurations of any of the first control valve or the second control valve in any of steps A through E based upon a comparison of pressures sensed by the first and second pressure sensors.

11. The method of claim 8 wherein the working vessel is the fluid chamber of a single-acting actuator and;
the single-acting actuator is placed in a first actuator position when the valves are configured in accordance with configuration step A and a second actuator position when the valves are configured in accordance with configuration step C.

12. A method for pneumatically actuating a double-acting actuator, the method comprising:
providing:
a first three-way control valve in fluid communication with a second three-way control valve and a third three-way control valve in fluid communication with a fourth three-way control valve: a) each control valve including a supply port, an exhaust port and an outlet port and capable of being configured in a first and second position in which in the first position the supply port is in fluid communication with the outlet port and the exhaust port is in fluid isolation and in the second position the exhaust port is in fluid communication with the outlet port and the supply port is in fluid isolation; b) the outlet port of the first control valve being in fluid communication with the supply port of the second control valve and the outlet port of the fourth control valve being in fluid communication with the supply port of the third control valve; and c) the supply ports of the first control valve and the fourth control valve being connected to a fluid supply and the exhaust ports of the second control valve and the third control valve being connected to an exhaust;
a fluid reservoir including a fluid port in fluid communication with the exhaust ports of the first control valve and the fourth control valve; and
a double-acting actuator having a first chamber including a first fluid port in fluid communication with the outlet port of the second control valve and a second chamber including a second fluid port in fluid communication with the outlet port of the third control valve; and
configuring the first control valve, the second control valve, the third control valve and the fourth control valve according to the following sequence:
A. configuring the first control valve into the first position, the second control valve into the first position, the third control valve into the second position and the fourth control valve into the second position so as to cause fluid from the fluid supply to flow into the first chamber of the double-acting actuator and the second chamber of the double-acting actuator to be in fluid communication with exhaust through the third control valve;
B. after configuration step A, maintaining the second control valve, the third control valve and the fourth control valve in their configurations of configuration step A and configuring the first control valve into the second position so as to cause fluid to flow from the first chamber to the reservoir;
C. after configuration step B, maintaining the first control valve, the third control valve and the fourth control valve in their configurations of configuration step B and configuring the second control valve into the second position so as to cause fluid to flow from the first chamber to exhaust and the fluid in the reservoir to be reserved;
D. after configuration step C, maintaining the first control valve, the second control valve and the fourth control valve in the configurations of configuration step C and configuring the third control valve into the first position so as to cause the reserved fluid to flow from the reservoir to the second chamber of the double-acting actuator; and
E. after configuration step D, maintaining the first control valve, the second control valve and the third control valve in their configurations of configuration step D and configuring the fourth control valve into the first position so as to cause fluid to flow from the fluid supply to the second chamber of the double-acting actuator.

13. The method of claim 12 wherein the first through fourth control valves are further configured according to the following configuration sequences:
F. after configuration step E, maintaining the first control valve, the second control valve and the third control valve in their configurations of configuration step E and configuring the fourth control valve into the second position so as to cause fluid to flow from the second chamber to the reservoir;
G. after configuration step F, maintaining the first control valve, the second control valve and the fourth control valve in their configurations of configuration step F and configuring the third control valve into the second position so as to cause fluid to flow from the second chamber to exhaust and the fluid in the reservoir to be reserved;
H. after configuration step G, maintaining the first control valve, the third control valve and the fourth control valve in their configurations of configuration step G and configuring the second control valve into the first position so as to cause fluid to flow from the reservoir to the first chamber; and
I. after configuration step H, maintaining the second control valve, the third control valve and the fourth control valve in their configurations of configuration step H and configuring the first control valve into the first position so as to cause fluid from the fluid supply to flow into the first chamber of the double-acting actuator.

14. The method of claim 13 wherein the method further includes:
providing at least two pressure sensors in electrical communication with a controller, whereby one of the at least two pressure sensors is in fluid communication with the reservoir and another of the at least two pressure sensors is in fluid communication with at least one of the chambers of the double-acting actuator;
sensing the pressure in the reservoir and in the at least one chamber of the double-acting actuator during any of steps A through H; and
controlling timing of the configurations of any of the first control valve, the second control valve, the third control valve, or the fourth control valve in any of steps A through H based upon a comparison of pressures sensed by the sensor in fluid communication with the reservoir and the sensor in fluid communication with at least one of the chambers of the double-acting actuator.
